(19) United States
(12) Patent Application Publication
(10) Pub. No.: US 2013/0281022 A1
(43) Pub. Date: Oct. 24, 2013

(54) Low-Power Wireless Beaconing Network Supporting Proximal Formation, Separation and Reformation

(71) Applicant: Intermec IP Corp., Everett, WA (US)

(72) Inventors: Ronald L. Mahany, Cedar Rapids, IA (US); Joseph J. Kubler, Boulder, CO (US); Thomas J. Schuster, Ceda Rapids, IA (US)

(21) Appl. No.: 13/907,893

(22) Filed: Jun. 1, 2013

Related U.S. Application Data
(62) Division of application No. 11/871,553, filed on Oct. 12, 2007.
Application No. 11/871,553 is a continuation of application No. 09/960,837, filed on Sep. 21, 2001, now abandoned.
Application No. 09/960,837 is a continuation of application No. 09/127,276, filed on Jul. 29, 1998, now abandoned.
Application No. 09/127,276 is a continuation of application No. 13/783,199, filed on Mar. 1, 2013.
Application No. 09/127,276 is a continuation-in-part of application No. PCT/US1998/002317, filed on Feb. 6, 1998.
(60) Provisional application No. 60/093,218, filed on Jul. 17, 1998.
(60) Provisional application No. 60/080,700, filed on Apr. 3, 1998.
(60) Provisional application No. 60/036,895, filed on Feb. 6, 1997.
(60) Provisional application No. 60/055,709, filed on Aug. 14, 1997.

(51) Int. Cl. H04W 4/00

(52) U.S. Cl. CPC H04W 4/008
USPC 455/41.2

(57) ABSTRACT

At least one of the wireless devices of a wireless network attempts to reestablish communications with a separated wireless device. Further, the separated wireless device may also attempt to reestablish communication with the wireless network. At least two of the wireless devices may separate from the wireless network to form an alternate wireless network separate from the wireless network. In such case, the at least two wireless devices of the alternate network may rejoin the wireless network after the separation. The wireless devices may establish the wireless network when proximate to one another and operating at a lower power level while continuing operation at a higher power level. The wireless devices establish the wireless network when in a first proximity to one another and continue to communicate while in a second proximity to one another.

### CROSS-REFERENCE TO RELATED APPLICATIONS

This application is a continuation of application Ser. No. 13/783,199 filed Mar. 1, 2013; the present application and said application Ser. No. 13/783,199 are each a division of application Ser. No. 11/871,553 filed Oct. 12, 2007, which is a continuation of application Ser. No. 09/960,837 filed Sep. 21, 2001, now abandoned, which is a continuation of application Ser. No. 09/127,276 filed Jul. 29, 1998, now abandoned, which claims the benefit under 35 USC 119(e) of U.S. Provisional Application No. 60/093,218 filed Jul. 17, 1998, and U.S. Provisional Application No. 60/080,700 filed Apr. 3, 1998; said application Ser. No. 09/127,276 is a continuation-in-part of PCT International Patent Application PCT/US98/02317 filed Feb. 6, 1998, published as WO 98/35453 on Aug. 13, 1998, and which claims the benefit under 35 USC 119(e) of U.S. Provisional Application No. 60/036,895 filed Feb. 6, 1997, and U.S. Provisional Application No. 60/055,709 filed Aug. 14, 1997.

### INCORPORATION BY REFERENCE

The applications identified above in the section entitled “Cross Reference to Related Applications” are hereby incorporated by reference in their entirety. The following applications and Appendices are also hereby incorporated by reference in their entirety.
1. U.S. Pat. No. 5,748,619, filed Dec. 26, 1996, and issued May 5, 1998.
2. U.S. Pat. No. 5,673,031, filed Jul. 5, 1994, and issued Sep. 30, 1997.
3. U.S. Provisional Application No. 60/043,395, filed Apr. 2, 1997, attorney docket number 38314P1.
4. U.S. Provisional Application for Russell W. Libonati entitled “Antenna Screw for Small Radio Devices”, filed Apr. 3, 1998 with Express Mali Label No. EB 047 970 011 US, attorney docket number 38337P1.
5. U.S. application Ser. No. 08/916,601, filed Aug. 22, 1997, attorney docket number 38314R.
6. U.S. application Ser. No. 09/053,275, filed Apr. 1, 1998, attorney docket number 38314R2.
The following APPENDICES A THROUGH I were originally filed in the parent application Ser. Nos. 09/127,276, 09/960,837, 11/871,553 and 13/783,199, and are hereby incorporated herein by reference:
7. APPENDIX A entitled ‘HARDWARE PERFORMANCE SPECIFICATION”, including pages 1-24.
8. APPENDIX B entitled “MICROLINK RADIO ARCHITECTURE AND PROTOCOL”, including pages 1-38.
9. APPENDIX C entitled “THEORY OF OPERATION WIRELESS PERSONAL AREA NETWORK”, including pages 1-9.
10. APPENDIX D “MICROLINK SPECIFICATION”, including pages 1-2.
11. APPENDIX E including pages 1-35 showing object code for a test release of Microlink. The code implementation of Microlink follows the state machine descriptions in APPENDIX E.
12. APPENDIX F including pages 1-10 showing descriptive slides on wireless data communication.
13. APPENDIX G entitled “PROPOSAL FOR A PERSONAL AREA NETWORK MEDIUM ACCESS CONTROL AND PHYSICAL LAYER”, including slides 1-25.
14. APPENDIX H containing engineering schematics of a Microlink Printed Circuit Board in accordance with the present invention, including Sheets 1-4 {B} for Board Number 144-781-007, Sheets 1-2 of Drawing Number 224-194 for Board Number 144-781-07, amt Sheets 1-4 of Drawing Number 144-781-007 for Board Number 114-781-07.
15. APPBNDIX I providing a parts list for the schematics contained in APPENDIX H.

### BACKGROUND

1. Technical Field

The present invention relates generally to wireless communication systems; and more specifically, to low power wireless networks that include a plurality of wireless devices, such wireless devices used in data collection applications, parcel delivery applications, and such other applications that require wireless communication between a plurality of portable devices.

2. Related Art

Wireless networks are well known in the art. Wireless networks are typically implemented in conjunction with an infrastructure network wherein a plurality of base stations (access points) allow wireless devices to communicate with the infrastructure network. The base stations provide wireless communications within respective cells and are typically spaced throughout a premises or area to provide wireless communications throughout the premises or area. Within the premises or area, wireless devices may communicate with devices connected to the infrastructure network. Further, the base stations and the infrastructure network facilitate communications between wireless devices operating within the premises or area.

Within the wireless networks, portable wireless devices communicate with the base stations. For example, in a data gathering application within a premises, a wireless data terminal communicates with one or more of the base stations when requiring communication with devices connected to the infrastructure network. Further, the wireless data terminal may communicate with other wireless devices connected to the wireless network via one or more base stations. However, such communications require relatively high power transmissions. Thus, because the portable data terminal is battery powered, the high power transmissions may significantly reduce battery life.

Wireless communications are generally managed according to an operating protocol. Most of these operating protocols require ongoing wireless activity. Such ongoing wireless activity, even merely to receive transmissions, further shortens battery life in battery powered portable devices, reducing the duration within which the devices may operate or requiring more frequent recharging or battery substitution.

Additional concerns in wireless communication relate to synchronization of radio timing. Such synchronization becomes especially critical in the management of wireless communications wherein scheduling future coordinated activities proves important to carry out operations or power saving strategies. Wireless devices typically provide their own timing mechanisms; however, it is common for the timing mechanisms to vary in their operations from device to device so that they fail to provide an accurate reference for synchronization.

Thus, there exists a need in the art for improved wireless communications, particularly with portable devices that operate with battery power. Further, there exists a need in the art for wireless communications which provide stable synchronization of wireless transmissions but also allow portable devices to conserve battery power while operating according to established protocols.

### SUMMARY OF THE INVENTION

These and other objects of the present invention are achieved in a low power wireless communication (personal LAN) system constructed according to the present invention. The personal LAN includes a plurality of wireless devices with each wireless device including a radio transceiver. The radio transceiver may take the form of an insertable card that fits within a slot in the wireless device. In operation, the plurality of wireless devices establish a wireless network. In the wireless network, at least two of the plurality of wireless devices share beaconing responsibilities to coordinate operation of the wireless network.

In the personal LAN, the beacons are provided on a periodic basis with at least two of the plurality of wireless devices sharing beaconing responsibilities. The beaconing responsibilities may be shared on a round robin basis or may be shared according to the operating characteristics of the wireless devices with some wireless devices assuming greater beaconing responsibilities than other of the wireless devices.

The plurality of wireless devices may include a primary beaconing wireless device. In such case, other wireless devices of the plurality of wireless devices coordinate their wireless communications to beacons provided by the primary beaconing wireless device. Further, the other wireless devices may coordinate low power operations to beacons provided by the primary beaconing wireless device. In this fashion, the other wireless devices may enter low power operations for multiple beacon cycles of beacons provided by the primary beaconing wireless device. The other wireless devices may also coordinate lower power operations based upon the contents of beacons received from the primary beaconing wireless device. The other wireless devices may also adjust timing parameters based on actual measurements so that they wake up appropriately from low power operations to receive the beacons from the primary beaconing wireless device.

The primary beaconing wireless device may also coordinate communications among the plurality of wireless devices. Alternately, the other wireless devices may coordinate their own communications but with reference to the beacons of the primary to beaconing device. Further, beaconing responsibilities may be coordinated to satisfy wireless device limitations. For example, should one of the wireless devices face an operating condition which prevents it from providing beacons, its beaconing responsibilities may be passed to other of the wireless devices.

At least one of the wireless devices may also communicate with an infrastructure network at a relatively higher power level. In this fashion, at least one wireless device may communicate with another wireless network via the infrastructure network.

In another embodiment of the personal LAN, one of the plurality of wireless devices may separate from the wireless network to become a separated wireless device. In such case, at least one of the wireless devices attempts to reestablish communications with the separated wireless device. Further, the separated wireless device may also attempt to reestablish communication with the wireless network. Such operations are accomplished with predetermined operations that are initiated upon sensing the separation.

In attempting to rejoin the wireless network, the separated wireless device may camp on a predefined channel, waiting for a beacon signal from at least one of the plurality of wireless devices with the separated wireless device rejoining the wireless network in response to receipt of the beacon signal. In another operation, the separated wireless device may scan a plurality of predetermined control channels for a beacon signal and may rejoin the wireless network in response to receipt of the beacon signal.

Should the separated wireless network device fail to rejoin the wireless network, it may selectively join another wireless network. Alternatively, the separated wireless network device may establish wireless communication with an infrastructure network.

In still another embodiment of the personal LAN, at least two of the wireless devices may separate from the wireless network to form an alternate wireless network separate from the wireless network. In such case, the at least two wireless devices of the alternate network may rejoin the wireless network after the separation. For example, the at least two wireless devices may form the alternate network when they are physically separated from the other wireless devices and rejoin the wireless network when in proximity to wireless devices of the wireless network.

When separated, at least one of the plurality of wireless devices not in the alternate wireless network may transmit beacon signals intended for the at least two wireless devices forming the alternate wireless network. These beacons signals may be transmitted on at least one control channel. In transmitting these beacon signals, the plurality of wireless devices may establish a beaconing pattern to coordinate operation of the wireless network prior to separation of the at least two wireless devices. After separation, the at least two wireless devices of the alternate wireless network may then continue transmission of the beaconing pattern. Then, the at least two wireless devices may recognize the wireless network based upon identification of the beaconing pattern.

In a further embodiment of the personal LAN, each wireless device includes a radio transceiver capable of transmitting at both a higher power level and at a lower power level. In the embodiment, the plurality of wireless devices establish a wireless network when proximate to one another and operating at the lower power level. Further, after establishment of the wireless network, the plurality of wireless devices communicate within the wireless network at the higher power level.

In the personal LAN, the plurality of wireless devices establish the wireless network when in a first proximity to one another. Further, the plurality of wireless devices communicate within the wireless network when in a second proximity to one another, wherein the first proximity is less than the second proximity. One of the plurality of wireless devices separates from the wireless network when it moves outside of the second proximity.

Further, in the embodiment, at least one of the wireless devices may also communicate with an infrastructure network. Such communications with the infrastructure network occur at a power level greater than the higher power level.

The present invention also includes a method of establishing a wireless network. The method includes selecting at least two wireless devices from a plurality of wireless devices, each capable of participation within the wireless network in a higher power mode, placing the at least two wireless devices in close proximity to one another, the at least two wireless devices interacting in a lower power mode to establish the wireless network, and returning to the higher power mode for wireless network communications.

Moreover, other aspects of the present invention will become apparent with further reference to the drawings and specification which follow.

### BRIEF DESCRIPTIONS OF THE DRAWINGS

A better understanding of the present invention can be obtained when the following detailed description in conjunction with the following drawings, in which:

FIG. 1 is a perspective diagram showing a wireless personal local area network (LAN) LAN with a plurality of network devices, each of the plurality of network devices being capable of transmitting beacons;

FIG. 2 is a perspective diagram showing the devices of the personal wireless LAN in communication with a base station that is part of an infrastructure network, employing relatively higher power wireless communications;

FIG. 3 is a perspective diagram showing two personal LANs, one of which is linked to a base station of an infrastructure network in its proximity, while the other personal LAN is not linked to any base station and works independently of the infrastructure network;

FIG. 4A is a timing diagram showing two consecutive beacons transmitted by stations on a personal LAN;

FIG. 4B is a timing diagram showing a plurality of devices responsible for transmitting consecutive beacons;

FIG. 5 is a timing diagram showing a device sleeping through multiple beacons while still being able to wake up in time for a subsequent beacon;

FIGS. 6A and 6B are diagrammatic views showing roaming devices on a low power personal LAN disassociating and establishing separate personal LANs;

FIG. 7 is a timing diagram showing a missing beacon from one of the devices of the lower power network with subsequent attempts by other devices to replace the missing beacon;

FIG. 8 illustrates a specific embodiment of a personal LAN according to the present invention operating to collect data and in coordination with an infrastructure network;

FIG. 9 illustrates operation of a personal LAN 801 according to the present invention in a route delivery scenario; and

FIG. 10 is a schematic block diagram illustrating the radio module and its interface with a host unit.

### DETAILED DESCRIPTIONS OF THE DRAWINGS

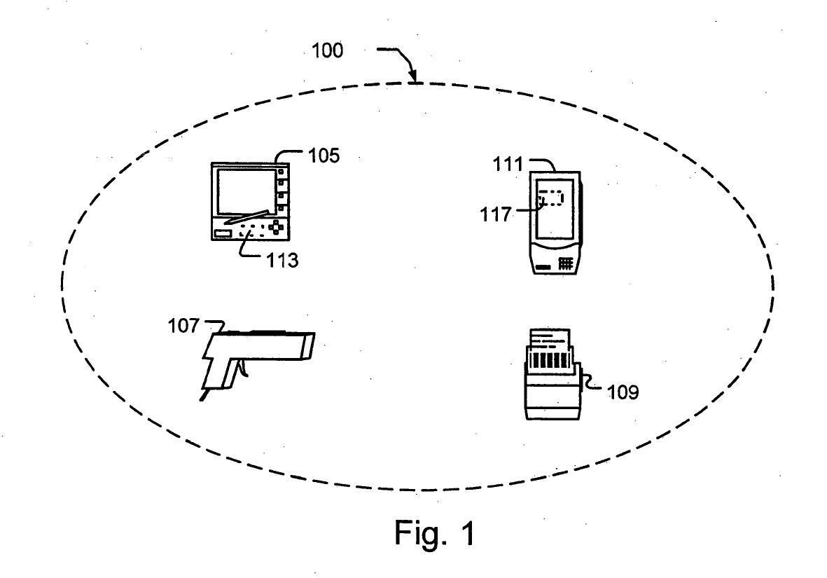

FIG. 1 is a perspective diagram showing an exemplary embodiment of a wireless personal LAN (local area network) 100 with a plurality of network devices 105, 107, 109 and 111, each of the plurality of network devices 105, 107, 109 and 111 being capable of transmitting beacons. Each of the devices 105, 107, 109 and 111 contain radio modules, such as a radio card 117, operating pursuant to a common communication protocol.

More specifically, a hand held device 105, a data collection device 107, a printer 109, and a personal digital assistant (PDA) 111 participate in distributed beaconing. The beacons that are transmitted by the devices 105, 107, 109, and 111 are primarily used for synchronization and identification purposes. Typically, one network device transmits a sequence of beacons while the other network devices synchronize to selectively receive the beacons. In the period between any two consecutive beacons, the network devices 105, 107, 109 and 111 selectively transmit and receive information from each other.

The wireless personal LAN 100 might support a small number of devices, e.g., (up to 10). A user selects a set of devices to be part of the personal wireless LAN 100 and initiates an automatic configuration process whereby the devices communicate with each other to establish the personal LAN. Alternately, the user establishes the personal wireless LAN 100 by collecting the desired devices and requesting the formation of the personal wireless LAN 100 via one of the devices such as the data collection device 107. The data collection device 107, through wireless interaction with the collected devices, delivers a list of candidate devices to the user for selection. Thereafter, through the data collection device 107, or through other initiating device, the personal wireless LAN 100 is formed. Alternatively, the personal wireless LAN 100 may be established using search and rescue operations as further described below.

In many environments, the selection of a set of devices is made from a great number of available devices. To prevent unselected devices from complicating or confusing network formation, the devices are all placed in very close proximity before initiating formation. Communication regarding formation takes place at very low power, avoiding unintentional participation by the unselected devices.

Specifically, in one embodiment of the personal LAN initialization activity, one of the devices in the personal LAN 100, such as the data collection device 107, sends an “initiate frame” to establish a personal LAN at a very low power level, perhaps reaching receivers no more that a few feet away. This frame is always broadcast, and it includes a type field indicating the type of network being created, and a network identification to identify the personal LAN being created. Devices receiving this frame will determine whether they want to join the personal LAN being initiated and request to join by sending an “attach request frame.” The attach request frame is broadcast using the network identification, and includes the address of the sending device. After receiving attach request frames from the other devices, the data collection device 107 sends an “attach response frame” (indicating acceptability of a device) to the devices that are to be included, the personal LAN 100.

The personal wireless LAN 100 operates in the vicinity of a high density of overlapping networks. For example, in one embodiment 15 to 20 personal wireless LANs can simultaneously independently operate within a 300 foot area. The personal LAN can also operate in the vicinity of an infrastructure network that is typically used in a warehouse or a factory as part of the work environment.

Although in one embodiment only a single network device, such as a data collection device 107, is responsible for transmitting beacons, in other embodiments, more than one network device selectively participates in distributed beaconing. Likewise, although beaconing intervals are rather fixed (i.e., of a predetermined duration), such intervals may vary depending on the intended functionality expected during each specific interval.

When more than one network device participates in distributed beaconing, they transmit beacons in either a predetermined order or in a dynamically determined order. Again, not all the network devices need to participate in such beaconing. Some of the network devices 105, 107, 109 and 111 may choose not to participate in beaconing depending upon their status, and the power levels of their batteries, etc.

In cooperation, the beacon signal protocol established allows each of the devices 105, 107, 109 and 111 within the wireless personal LAN 100 to enter power-saving sleep modes without compromising wireless personal LAN structure or communications. The protocol also supports beacon hand-off and backup beacon functionality to support separation of a personal wireless LAN 100 into two or more subnetworks as well as the automatic reformation thereof back into a single personal LAN.

Typically, one of the beaconing devices is considered to be the network coordinator and is responsible for rescuing lost devices and allowing other devices to join the network. For example, the printer 109 can be designated as the network coordinator and made responsible for network management, network membership changes and rescue missions. Although the network coordinator may typically be the beaconing device, any non-beaconing device may take on such responsibilities as network coordinator.

In some embodiments, the network controller hands off the responsibility for rescuing lost devices to one or more of the other devices of the network. In this way, the network controller is able to perform other network management responsibilities while the one or more of the other devices assume the burden of search and rescue operations. This also proves advantageous when the network management responsibilities otherwise conflict with the search and rescue operations, and when the network management burden on the network controller is already significant.

The beacons are typically frames that include information about network time, dwell time and next beacon time. With such information a device may schedule its receiver to wake to receive a subsequent beacon and then enter a low power “sleep” mode until the time arises. In addition, beacons may also include a count of the number of beacons that have been sent or other time stamp indication. This allows a radio to occasionally take snapshots of its own clock and then at some larger number of beacons intervals later, sample the beacon count again and determine the radio's relative accuracy versus the underlying clock employed for beaconing. This allows for periodic adjustments of all network device (“radio”) clocks to that of the beaconing device.

The personal wireless LAN 100 employs frequency hopping spread spectrum transmissions. Alternately, direct sequence or hybrid spread spectrum techniques could be employed. Like wise, other transmission technologies might be employed. With frequency hopping, the available frequency band is divided into a number of channels and the transmission hop from channel to channel occurs in a specified sequence.

A few of the channels are designated as control channels, and are used for coordinating search and rescue operations of lost roaming devices, in addition to the selective transmission of control signals. The hop sequences will visit these channels more frequently. Several channels are also used to prevent a single point of failure based on interference on a single channel. In such environments, the beacons may also include hop information indicating how much time is remaining in the current dwell, the current channel, the hop table in use and the table entry.

The personal wireless LAN 100 is a low power network with a small range that makes it possible for some of the roaming devices to get out of the range of the network. When this happens, the personal wireless LAN 100 initiates search and rescue missions. In one embodiment of the search and rescue mechanism, one of the beaconing devices in the personal wireless LAN 100, the printer 109, for example, or any other device having the role of network coordinator, generates “identity” frames to provide an opportunity to the roaming devices to confirm their connectivity. Devices that receive the identity frames communicate with the network coordinator to confirm their continued participation in the personal LAN 100. For devices that do not respond to the identity frames and are determined to be “lost,” a search and rescue mission is initiated for a specified number of beacons. After this period, the network coordinator will wait for an indication of no activity involving it, and then tune to each of a plurality of control channels in succession and transmit beacon frames. Lost devices will tune to at least one of the control channels, and when they receive a beacon, they will resync to the information in the beacon and thus be recovered. Such search and rescue operations may also be employed to establish the wireless personal LAN 100 when proximal formation operations (as described above) are not desired.

The beacons are sent at fixed intervals of time. Alternately they may be sent at variable intervals. When the beacons are sent at variable intervals, they can be sent at predetermined intervals of time or at intervals specified dynamically in preceding beacons. A device that has not seen beacons in a given cycle will scan the designated control channels, waiting for beacons. Once it sees a beacon, it resynchronizes (resync's).

Devices join the personal wireless LAN 100 by sending requests to the network coordinator to join that network. The network coordinator can accept or reject the device that wants to join the network. A network device that finds itself isolated due to roaming can choose to join another network in its proximity.

In one exemplary embodiment, a single network device, such as the hand held device 105, transmits beacons at fixed beaconing intervals. The other devices 107, 109 and 111 using their synchronized radios, receive the beacons from the hand held device 105. In particular, the data collection device 107, the printer 109 and the PDA 111 use the occurrence of the beacon and the information contained therein to synchronize their clocks and to coordinate their communication with other devices. The hand held device 105 transmits a beacon and each personal LAN device stays awake for a period called the “awake time window” to receive communication from other of the personal LAN devices 107, 109 and 111. Communication is typically scheduled during the awake time window for the time period available thereafter. An exception might be small data packets of duration not justifying scheduling overhead. If no communication involving a network device is anticipated, after the awake time window lapses, the device may choose to sleep for the rest of the current beacon cycle.

The hand held device 105, as the network coordinator, periodically requests that all the other devices in the personal LAN 100 confirm their presence. It may also periodically offer other devices in the proximity of the personal LAN 100 an opportunity to join the personal LAN 100.

If the traffic on the personal LAN 100 is low, the devices on the personal LAN 100 sleep most of the time. They need to be awake to receive beacons to synchronize their clocks and during the awake time window any need to receive or to request an opportunity to send. The devices 107, 109 and 111 can choose to sleep for multiple beacon cycles and wake up for the “n^{th}” beacon. The network coordinator 105 is typically made aware of such multiple cycle sleep modes by the devices 107, 109 and 111. All communications with a sleeping device is coordinated by the network coordinator and scheduled for the beacon cycle for which the individual device is expected to be awake.

If the battery of a device, such as the PDA 111, is replaced, the PDA 111 re-acquires the network. The personal LAN itself does not determine that the device is missing for the duration of the PDA's 111 resync time. This period can be quite long. To facilitate the recovery of such devices, the hop sequences of the frequency hopping spread spectrum protocol incorporates the control channels in the sequence more frequently than other channels. Thus a device that is lost can wait on a control channel for beacons. If the lost device is the network coordinator (the station that normally transmits beacons), then after a short number of missing beacons, another device, the data collection device 107 for example, will send backup beacons. Thus, even the lost network coordinator will be able to recover the network.

In another embodiment, the hand held device 105 acting as a network coordinator sends beacons and also forwards messages received from one device addressed to another. More specifically, if any of the devices 107, 109 and 111 need to communicate information to any other device in the wireless personal LAN 100, the originating device sends the information, along with the address of the designated recipient, to the network coordinator 105. The network coordinator 105 subsequently transfers the received information to the recipient device. Such information can be sent by the sending device to the network coordinator 105 during a designated slot in a beacon cycle or during a contention period following the beacon, when the hand held device 105 is awake to receive communication from the other devices. In this embodiment, the network coordinator 105 stores messages from the other devices and forwards them to the recipient devices subsequently. Devices that do not have to communicate can sleep immediately after a beacon. Devices that have to communicate with the network coordinator do so during the awake time window after a beacon when the network coordinator 105 listens to traffic on the personal LAN 100.

In another exemplary embodiment, the network devices 105, 107, 109 and 111 transmit their beacons employing a round-robin ordering strategy. In such a distributed beaconing environment, the hand-held device 105 first transmits its beacon, followed later by beacons from the data collection device 107, the printer 109, and the PDA 111. When one of the devices, such as the data collection device 107, decides to halt beacon transmissions, the other network devices 105, 109, and 111 continue transmitting their beacons in round-robin order. Alternately, other round robin strategies for beaconing involving multiple inclusions of specific devices within the round robin order may be employed. In this embodiment, all the devices on the personal LAN 100 stay awake for a “awake time window” that follows a beacon, during which they communicate with the beaconing device or with each other.

In a different round robin embodiment, one of the devices, such as the hand held device 105, acts as the network coordinator and broadcasts beacons that are used as the master beacon or a primary beacon. The beacons transmitted by the other devices 107, 109 and 111 are considered to be secondary beacons. The primary beacon is used for clock synchronization by all the devices on the personal LAN 100. The secondary beacons are used to identify the presence of the associated device. The loss of a secondary beacon could indicate the loss of its associated device and trigger a rescue attempt by the network coordinator 105.

Devices that participate in beacon transmissions may suspend their own beacon transmissions for several reasons. If the battery power of the data collection device 107 participating in distributed beaconing goes below a threshold level, the data collection device 107 may selectively decide to temporarily suspend transmission of its beacons. When this occurs, the other devices 105, 109 and 111 recognize the suspension of beacon transmissions by the data collection device 107. In response, the other three network devices 105, 109 and 111 continue beaconing in round-robin order. Alternately, one of the other network devices 105, 109 or 111 transmits beacons in the place of the data collection device 107.

Each of the network devices 105, 107, 109 and 111 includes a clock. For example the hand held device 105 includes a clock 113 that it uses for several purposes including scheduling communications and for sleeping multiple beacons. The devices 105, 107, 109 and 111 also include a radio card, such as the radio card 117, for communicating with each other. In most devices, a radio card operates in coordination with a microprocessor or an onboard computer (not shown). In some devices, such as “dumb” devices (such as a printer or the like), the radio operates independently of the microprocessor or host computer, and provides a wireless communication link for the dumb device. A dumb device is that which is typically designed for, or currently programmed for, wired link communications and that is generally unaware of a radio installation.

When the personal LAN separates into two different LANs, the beacon order of both LANs may be unaltered. If the clocks in each device are not synchronized with each other, it will be difficult for the devices to receive beacons. The beacons are therefore used to synchronize the clocks. Specifically, one of the beaconing devices, called the network coordinator, is considered to be the primary beaconer and its beacons are used by the other devices to calculate the difference between their clocks and the clock of the network coordinator. By determining this clock difference, each device is able to wake up just before the next beacon. The differences in the clocks can be more accurately calculated if they are measured over a large number of beacons. Therefore, each device on the personal LAN takes a snapshot of its clock periodically, and after some large number of beacons, determines its clock's relative accuracy versus the network clock transmitted by the network coordinator. This enables each device to determine the difference between its clock and the network clock more accurately.

Knowing the corrections to be made to its own clock for synchronization with the network clock enables the network devices on the personal LAN to sleep through multiple beacon cycles and still be able to wakeup in time for a subsequent beacon. Again, each device can save power by minimizing the wakeup window required to receive a beacon. This is achieved by initially selecting a wakeup window wide enough to receive the first few beacons, and gradually tightening the wakeup window so that the wakeup window starts almost exactly in synchronization with a beacon.

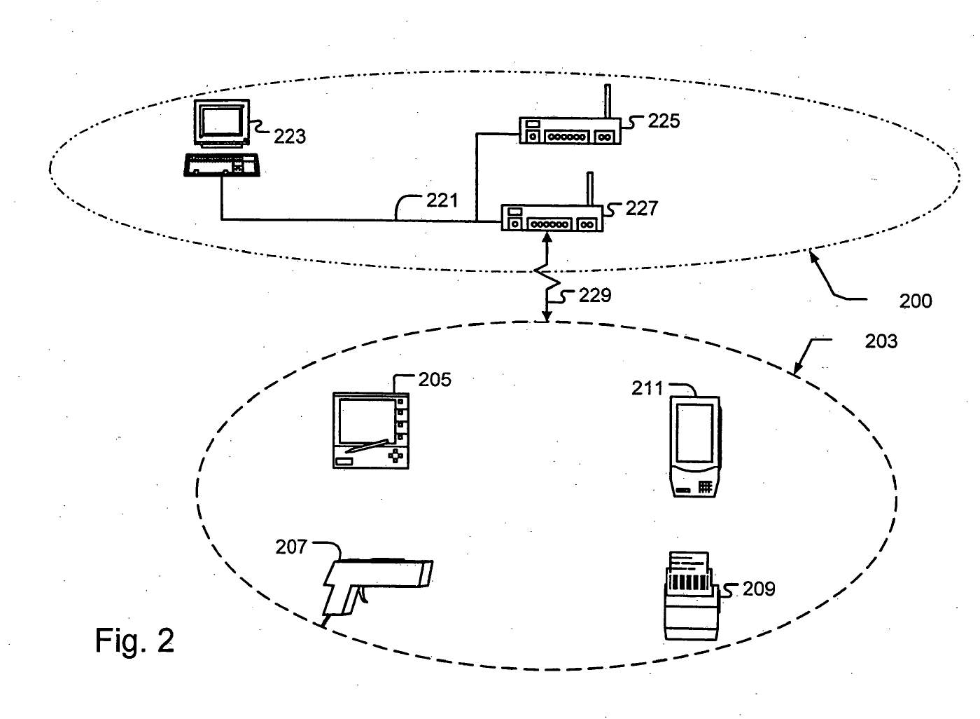

FIG. 2 is a perspective diagram showing the devices of the personal wireless LAN 203 in communication with a base station 227, that is part of an infrastructure network 200, employing a relatively higher power wireless communications 229. The hand held device 205, the data collection device 207, the printer 209 and the PDA 211 communicate with the base station 227 employing wireless links 229. Through the base station 227, the devices 205, 207, 209, and 211 communicate with a host computer 223 and with other personal LANs (not shown in the diagram). The base station 227 employ communication links 221 to communicate with the host computer 223 and another base station 225. The communication link 221 can be a wired communication link or a high powered wireless communication link. The communication link 229 between the personal LAN 203 and the base station 227 may be high powered or low powered, depending on the distance between the base station 227 and the personal LAN 203, the data rates necessary, and the protocols to be employed.

In establishing and maintaining communication with the infrastructure network 200, the personal LAN 203 may designate one or more of the devices 205, 207, 209 and 211 within the personal LAN 203 as an interface to the infrastructure network 200 depending upon data transmission requirements, power consumption and communication protocol constraints. In this fashion, communication between devices within the personal LAN 203 may be had without routing communications through the infrastructure network. Such operations proves advantageous in reducing network traffic on the infrastructure network 200 and allowing the devices within the personal LAN 203 to operate at a low transmitted power when communicating within the personal LAN 203. Further, such operation allows the devices 205, 207, 209, and 211 within the personal LAN 203 to communicate when outside the range of the infrastructure network 200.

Alternately, one or more devices that are part of the wireless personal LAN 203 acts as an access point to the infrastructure network 200. For example, the base station 227, while participating in the infrastructure network 200, may also participate in the personal LAN 203. It can communicate with another base station 225 and the host computer 223. It can also communicate with the hand held device 205, the data collection device 207, the printer 209 and the PDA 211 over the low powered personal LAN 203. Thus, while being part of the low powered wireless personal LAN 203, the base station 227 also participates in the high powered infrastructure network 200. The base stations 227 and 225 each may establish a respective personal LAN or communication cell. The base station 227 plays the role of a wireless access point. It may participate with a multi-hop wireless network that includes the other base station 225.

To initiate the personal LAN 203, the base station 227 or one of the devices assembled together for the personal LAN, such as the hand held device 205, transmits an initiate command. The initiate command would include the network id to use for the network, the data rate, the type of network, the power level to be used, the information being sent to potential joiners, and the length of the information being sent. In an exemplary initiate command, the type of the network could be specified as a personal LAN or as infrastructure network, the data rate could be specified as 250 Kbps or 1000 kbps, and the power level could be specified as one of 3 for full power, 2 for −20 db, 1 for −40 db, or 0 for −60 db. To establish a personal LAN, the data rate would be specified as 1000 kbps, the type of the network would be a personal LAN, and the power level could be set to the lowest power level. In the case of distributed beaconing personal LANs, the initiate command includes solicitation of information on a device's ability to beacon.

The device sending the initiate command, the base station 227 or the hand held device 205, then waits for the attach requests from the other devices in its proximity. The devices that receive the initiate command may choose to reply using an attach request. The attach request would include an address of the requesting device, the type of the remote device that identifies one of several possible radio modules, the information that the remote devices needs to pass to the initiating device, and the length of that information. In the distributed beaconing situation, an attach request also includes information on the device's ability to participate in distributed beaconing. The initiating device, such as the hand held device 205, then sends a join response to indicate acceptability of a remote device in the personal LAN that is being initiated. The join response includes the address of the remote device and a status field indicating acceptance or rejection. In the distributed beaconing situation, the join response also includes information on the device's role in distributed beaconing.

Subsequently, once the base station 227 or the hand held device 205 has determined that all required devices have joined the personal LAN being initiated, a start network command is sent. The start network command includes the dwell time of network in network ticks, where one tick is approximately 30.5 microseconds for an exemplary embodiment. It also includes a device resync time, which is the number of beacon intervals between attempts to recover missing devices from the network, the beacon interval in terms of frequency hops, the number of devices likely to transmit in any dwell interval, and a mode indicating the type of network—personal LAN or infrastructure. The start network command is also used to restore old networks.

The devices receiving the start network command from the base station 227 or the hand held device 205 send a start network response that includes information on the success or failure in starting the new network. For old networks being reinitiated, the start network response indicates the success or failure in reinitiating an old personal LAN or infrastructure network.

In operation, after initialization of the personal LAN's 203 operation, each of the devices 205, 207, 209, and 211 communicates with each other within the personal LAN 203 via low power communication. When communication is not required by a particular device, the radio modules enter a low power or “sleep mode” to conserve battery power. During such sleep modes, other circuitry within the device may also be powered down.

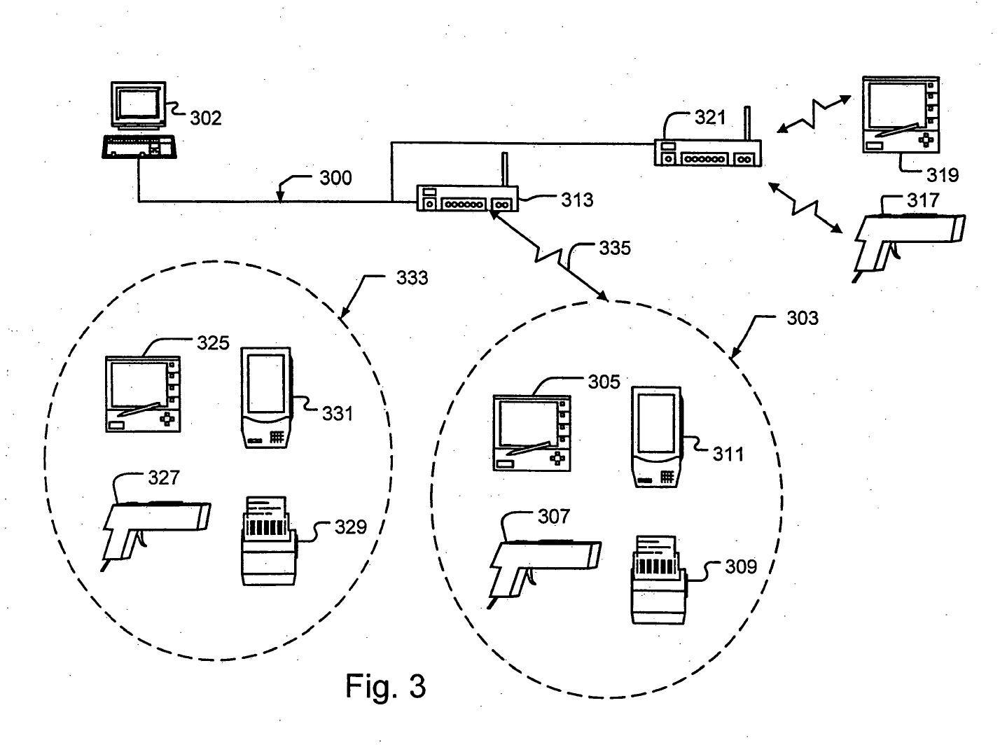

FIG. 3 is a perspective diagram showing two personal LANs 303 and 333, one of which 303 is linked to a base station 313 of an infrastructure network 300 in its proximity, while the other personal LAN 333 is not linked to any base station and works independently of the infrastructure network 300. The personal LAN 333 includes a hand held device 325, a data collection device 327, a printer 329, and a PDA 331. These devices communicate with each other over the low power personal LAN 333 after they have been initially configured. The devices 305, 307, 309, and 311 not only communicate with each other over the low power personal LAN 303, but are also able to communicate with other devices, such as a host computer 302, a data collection device 317, and a hand held device 319, via a base station 313 and over the wireless communication link 335 and the infrastructure network 300. The wireless link 335 may be a low power wireless link or a high power wireless link, depending upon the individual devices, the data rate, the traffic, and the protocols.

The infrastructure network 300 may depend on a base station, such as the base stations 313, for distributing messages to and from a host computer to the personal LANs. It may also depend on a base station to distribute messages within the infrastructure network from one base station in the network to another. No physical addresses are assumed in either case and a flexible host interface is provided in each network device, such as in devices 305, 307, 311, 309, to allow connection to a variety of base stations.

The base station 313, being part of the infrastructure network 300, provides data transfer between the wired physical medium and wireless devices, and may also provide a wireless link between wired Ethernet segments. Specifically, the base station 313 acts as a wired bridge access point that attaches to the infrastructure network through a communication link, such as an Ethernet link, and has bridging enabled. It converts wireless personal LAN frames from the personal LAN 303 to Ethernet frames, and Ethernet frames to wireless personal LAN frames. It also forwards wireless personal LAN frames to wireless personal LAN devices. Although, the base station 313 is shown wired to the infrastructure network 300, it may employ a high power wireless means to communicate with the infrastructure network 300. The base station 313 may participate with the personal LAN 303 as an infrastructure device, or may be part of the personal LAN 303 itself.

The data collection device 317, and the hand held device 319 are not part of any personal LAN. They communicate with a base station 321 that is part of the infrastructure network 300. The communication between the base station 321 and the devices 319 and 317 may employ low power wireless communications or high power communications depending upon the individual devices, the data rate, the traffic, and the protocols.

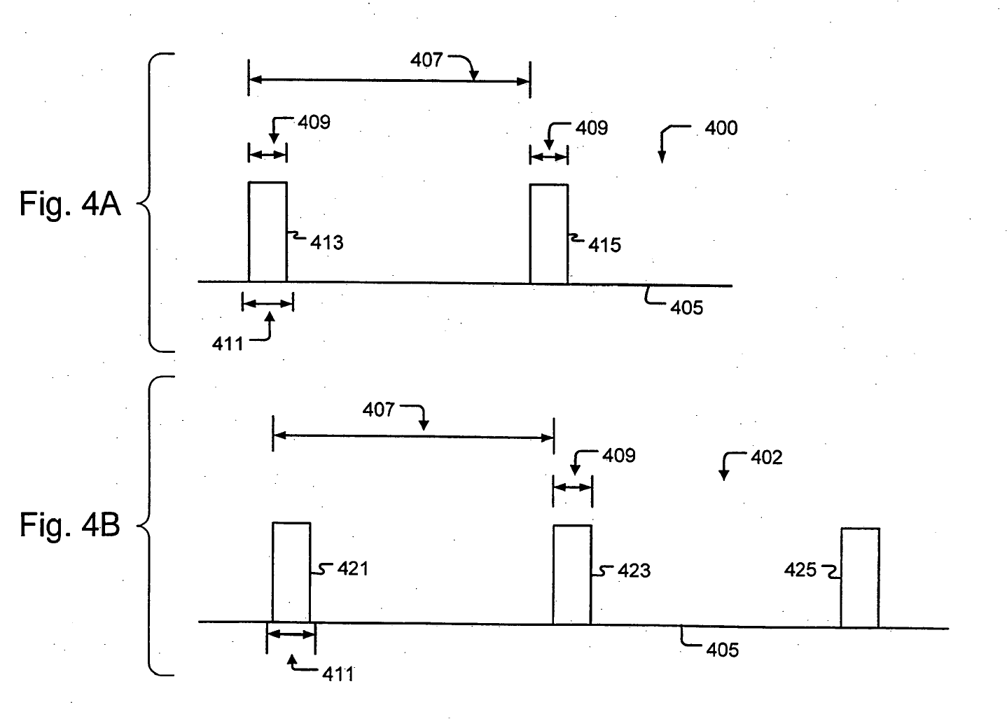

FIG. 4A is a timing diagram 400 showing a window of two consecutive beacons 413 and 415 of a plurality of beacon transmissions originating from at least one device on a personal LAN. The time line 405 shows two beacons 413 and 415, each transmitted for a duration 409, the beacons occurring with a beacon cycle 407. The beaconing station may be a network coordinator or another device participating in distributed beaconing. To send a beacon for the beacon duration 409, the sending device must participate in the beaconing protocol and be assigned beaconing responsibility. In the distributed beaconing environment, the beacons 413 and beacon 415 are likely to be transmitted by different beaconing devices. If only one device, e.g., the network coordinator, is responsible for beaconing, the beacons 413 and 415 originate from the network coordinator.

During the beaconing duration, beaconing information may be transmitted by a beaconing station on the personal LAN, and received by all the other devices on the personal LAN.

At a minimum, a beacon gets to coordinate communication activity. It used to synchronize operation and may contain information such as pending message lists, scheduling information or other network related indicia. Devices that are in a multiple cycle sleep mode may sleep through multiple intervening beacons. The beacon transmission cycle 407 is the duration between two consecutive beacons. The devices listening for the beacon stay awake for the beacon in a window called the wakeup window 411. Following the beaconing duration 409, an awake time window may be optionally invoked for some beaconing protocols during which the network coordinator or the beaconing device listens to network traffic and communicates with the other devices.

The beacon transmission cycle 407 may or may not be predetermined. It may also vary with the data rate, the traffic and the protocol. If it is predetermined, the devices in the personal LAN know when the next beacon is likely to occur. If it is not predetermined, then a given beacon identifies the time of occurrence of the next beacon. The beacon can be a frame that includes a network time stamp which is a timestamp of the beacon in network ticks of 30.5 microseconds, a next beacon time in terms of hops, a next beacon type, a beacon interval in units of hop dwells and a beacon count modulo 65536. The network time stamp is used to synchronize receiver's clocks. The beacon frame also includes a request for poll window time in network ticks to allow devices to indicate their need to communicate with the beaconing device or network coordinator, a device resync time that indicates the number of beacons that can be missed before entering resync mode, and a next hop time. The next hop time indicates the time left in the current dwell from start of the beacon frame.

Additionally, the beacon frame includes the dwell time in network ticks, the hop sequence being used the frequency hop based communications protocol, the current hop index, and a channel number indicating the actual channel that the beacon is transmitted on. The actual channel number is helpful to the receiving device because of the possibility of hearing adjacent channels.

In an exemplary beacon frame, the type of beacon can be 0 for normal beacon from network initiator, 1 for reset beacon from a network coordinator indicating need to resynchronize, 2 for backup beacon that is generated by a station other then the network coordinator. The type 2 also indicates that the beacons from the network coordinator have recently occurred and will occur later in the beacon sequence. For distributed beaconing, the next beacon type information may be accompanied by information on the next beaconing device indicating the device that would beacon next. This would facilitate dynamic reconfiguration of the personal LAN while providing for the dynamic determination of the next beaconing device depending on the data rate, the protocols, the power levels and the status of the devices.

FIG. 4B is a timing diagram 405 showing a plurality of devices responsible for transmitting consecutive beacons 421, 423, and 425 that are part of a continous beacon sequence. Beacons 421, 423 and 425 are transmitted by the hand held device 105, the data collection device 107 and the printer 109, respectively, in a round robin beaconing protocol. In this exemplary embodiment of the round robin beaconing protocol, the PDA 111 does not participate in beaconing. One of the beaconing devices, for example the hand held device 105, may be considered to be the network coordinator. The beacon 421 transmitted by the network coordinator may be considered to be the primary or the master beacon, and may be used by the other devices to synchronize their clocks. The other two beacons 423 and 425, transmitted by the data collection device 107 and the printer 109, respectively, are then considered to be secondary beacons, and are employed primarily to confirm the continued presence of those devices in the personal LAN 100.

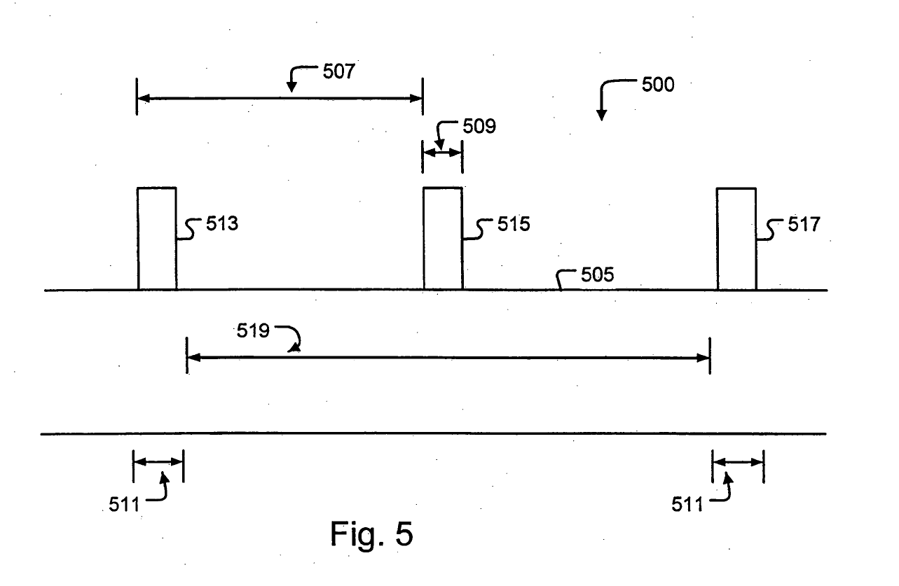

FIG. 5 is a timing diagram 505 showing a device sleeping through multiple beacons while still being able to wake up in time for a subsequent beacon. In this exemplary embodiment of the present invention, beacons 513, 515 and 517 are sent the hand held device 105, the data collection device 107, and the printer 109, respectively. The PDA 111 does not send beacons, and sleeps for multiple beacon cycles. Specifically, the PDA 111 wakes up for a wakeup window 511 to receive the beacon 513 from the hand held device 105, sleeps through the beacon 515 transmitted by the data collection device 107, and wakes up in time to receive the beacon 517 transmitted by the printer 109. It therefore sleeps for a multiple cycle sleep time 519, with each beacon transmission cycle being 507.

In another embodiment, the PDA 111 does not send beacons, and sleeps for multiple beacon cycles only to wake up to receive the beacon 513 sent by the hand held device 105. In such an embodiment, the hand held device 105 would be considered as the network coordinator, and the other non-beaconing devices would coordinate their sleep and wakeup schedules with the network coordinator.

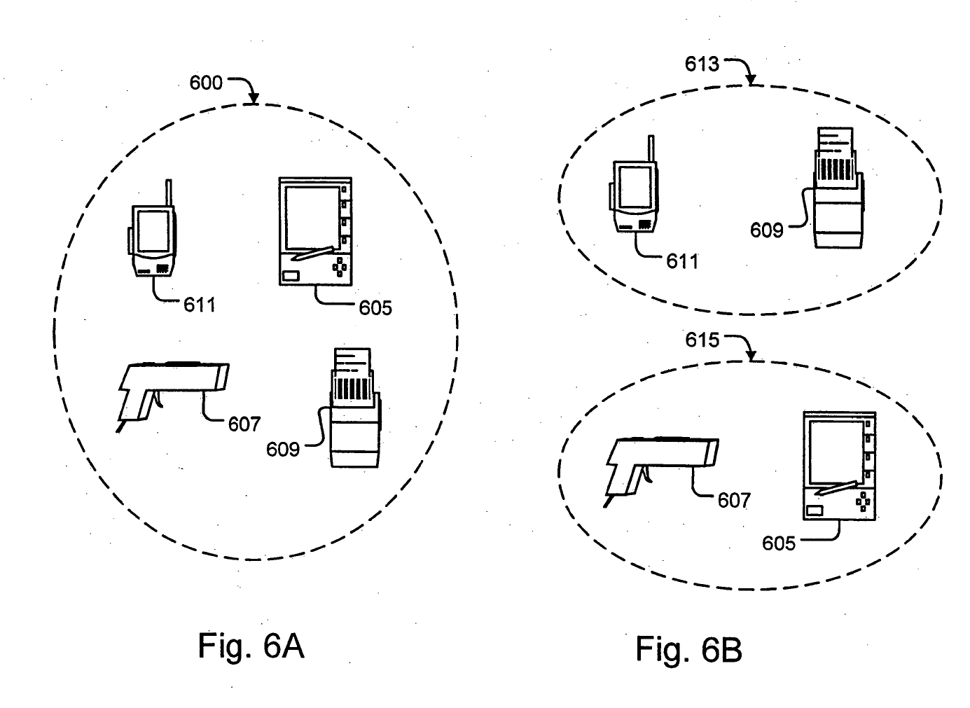

FIG. 6 is a perspective diagram showing roaming devices on a low power personal LAN 600 disassociating and establishing separate personal LANs 613 and 615. The personal LAN 600 includes a hand held device 605, a data collection device 607, a printer 609, and a PDA 611. In an exemplary embodiment, the devices 605, 607, 609, and 611 communicate with each other employing a distributed round robin beaconing protocol. The hand-held device 605 is the network coordinator and transmits primary beacons periodically in round robin order with the other devices, while the other devices in the personal LAN 600 transmit secondary beacons.

The devices in the personal LAN 600 are typically worn using appropriate attachments by a worker working in a warehouse or by a delivery person working in and out of a truck. Most of the devices in such work environments are portable, such as the devices 605, 607, 609 and 611, and some of these devices are not carried on the person of the worker when they are not needed. The personal LAN 600 is therefore dynamically configurable, and can identify the presence or absence of the devices in the personal LAN. The operation of the personal LAN 600 is continued and not disrupted despite the lack of participation or absence of some of the devices 605, 607, 609 and 611.

The network coordinator 605 assesses all devices in the network by monitoring the request for poll activity from the other devices and its own traffic to other stations. It can therefore determine which devices on the personal LAN 600 have recently been connected. By monitoring the secondary beaconing activity it can also ascertain which devices are still connected. For those stations without recent demonstration of connectivity, the network coordinator 605 generates identify frames. The lack of an appropriate response to the identify frames by devices that show no sign of activity will cause the network coordinator 605 to initiate a recovery mode or search and rescue operation.

For example, during the operation of the personal LAN 600, when the devices 609 and 611 are separated from the other two devices, the network coordinator 605 and the data collection 607 fail to receive the beacons from the printer 609 and the PDA 611. The network coordinator 605 then initiates a recovery mode or search and rescue operation for a number of beacons that was initially specified by the lost devices. After the requested number of beacons has passed, the network coordinator 605 will wait for an indication of no activity involving the lost devices 609 and 611, and then tune to each of the control channels in succession and transmit beacon frames.

The lost devices, the printer 609 and the PDA 611, are expected to wait on one of the control channels. When they receive the beacon, they proceed to resync to the information in the beacon and thus are recovered. If the printer 609 and the PDA 611 are separated and are out of the range of the personal LAN 600, they will not receive beacons from the network coordinator 605 and the data collection device 607. They progress very slowly through the control channels, waiting for beacons. However, the printer 609 and the PDA 611 continue to transmit their beacons, and continue to receive each others beacons. When they fail to see any beacons from the network coordinator 605 for a predetermined number of beacon transmission cycles, the printer 609 and the PDA 611 communicate with each other to identify a replacement for the network coordinator. For example, the printer 609 and the PDA 611 may elect the printer 609 to become the network coordinator and establish the personal LAN 613 for their continued operation.

In the meanwhile, the hand held device 605 abandons an unsuccessful search and rescue attempt for the devices that a number of beacon cycles. The hand held device then reconfigures the personal LAN 600 into the personal LAN 615 with itself as the network coordinator. When the devices 609 and 611 constituting the personal LAN 613 later come closer in proximity to the personal LAN 615, they may selectively rejoin the personal LAN 615 at the discretion of the network coordinator 605.

Devices that are separated or “lost” from the personal LAN 600 may rejoin the personal LAN 600 when they return to the proximity of the personal LAN 600. This is accomplished when these “lost” devices send a join request that includes the type of network the device wants to join, the number of beacons after missing which the device generates network beacons, the number networks and the network addresses of networks that the device is willing to join. The lost devices then await a join network response from the network coordinator of the personal LAN 600. The lost devices then send network management command to get addresses and types of other stations in the network. They then await the response and save information for use in other data messages subsequently.

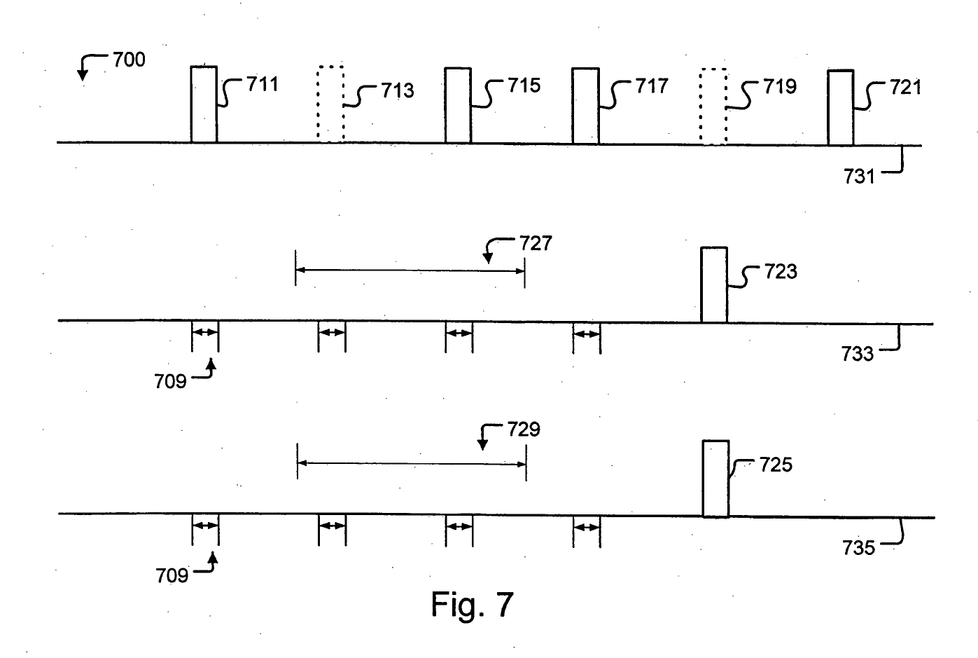

FIG. 7 is a timing diagram showing a missing beacon from one of the devices of the lower power network 100 with subsequent attempts by other devices to replace the missing beacon. Specifically, when the hand held device 105, the data collection device 107, and the printer 109 participate in distributed round-robin beaconing, each device transmits a beacon in succession and all the devices in the personal LAN can determine the device associated with a missing beacon.

The time line 733 corresponds to the activity of the hand held device 105 while the time line 735 corresponds to the activity of the printer 109. The hand held device 105 and the printer 109 wake up periodically for a wakeup window 709 to receive beacons. They also send beacons when it is their turn to transmit beacons.

The hand held device 105, the data collection device 107, and the printer 109 are expected to transmit the beacons 711, 713 and 715 respectively, in that order. However, when the data collection device 107 fails to transmit the beacon 713, the other devices 105, 109, and 111 listening to the beacons identify the source of the missing beacon as the data collection device 107. If the data collection device 107 is the network coordinator, both the beaconing devices 105 and 109 try to replace the missing beacon 719 with their own beacons 723 and 725, respectively. The contention for replacing the missing beacon 719 from the network coordinator 107 is recognized by all the devices on the personal LAN 100, and the contending devices decide to resort to a random back-off period across multiple beacon cycles to resolve the contention. The device that recovers first from the back off period and transmits its beacon as a replacement to the missing beacon is subsequently allowed to replace beacons from the data collection device 107.

If the data collection device 107 that stops sending beacons is not a network coordinator, and the hand held device 105 is the network coordinator, then the network coordinator 105 decides to replace the missing beacon from the data collection device 107 by its own beacon. The printer 109 refrains from transmitting its beacon in contention with the network coordinator 105. If the data collection device 107 decides later on to participate in distributed beaconing, it coordinates its inclusion with the network coordinator 105.

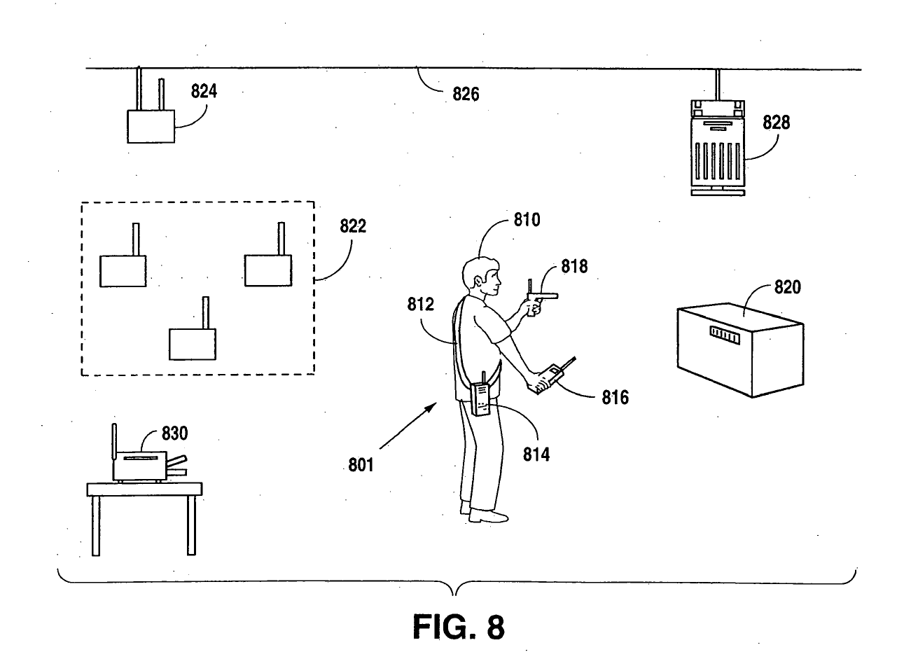

FIG. 8 illustrates a specific embodiment of a personal LAN 801 according to the present invention operating to collect data and in coordination with an infrastructure network. The personal LAN 801 includes a plurality of devices each having a radio module for enabling communication between itself, other devices within the personal LAN 801 and the infrastructure network. Such a personal LAN 801 may be used by a person 810 in gathering data such as in a factory environment and may include, for example, a printer 814, a data terminal 816 and a code reader 818, such devices perhaps attachable to the person via a harness 812. In operation, after initialization of the personal LAN's operation, each of the devices within the personal LAN 801 communicates with each other device within the personal LAN 801 via low power communication.

When communication is not required by a particular device, the radio modules enter a low power or “sleep mode” to conserve battery power. During such sleep modes, other circuitry within the device may also be powered down.

The personal LAN 801 may also establish communication with the infrastructure network when required. The infrastructure network may include a wired network having a wired backbone 826 connecting computer devices 828 to a wireless access point 824. The wireless access point 824 may participate with a multi-hop wireless network 822 having a plurality of wireless access devices, each establishing a respective communication cell. The multi-hop wireless network 822 may include, for example, printers 830 and other devices communicating wirelessly.

In establishing and maintaining communication with the infrastructure network, the personal LAN 801 may designate one or more of the devices within the personal LAN 801 as an interface to the infrastructure network depending upon data transmission requirements, power consumption and communication protocol constraints. In this fashion, communication between devices within the personal LAN 801 may be had without routing communications through the infrastructure network. Such operation proves advantageous in reducing network traffic on the infrastructure network and allowing the devices within the personal LAN 801 to operate at a low transmitted power when communicating within the personal LAN 801. Further, such operation allows the devices within the personal LAN 801 to communicate when outside the range of the infrastructure network.

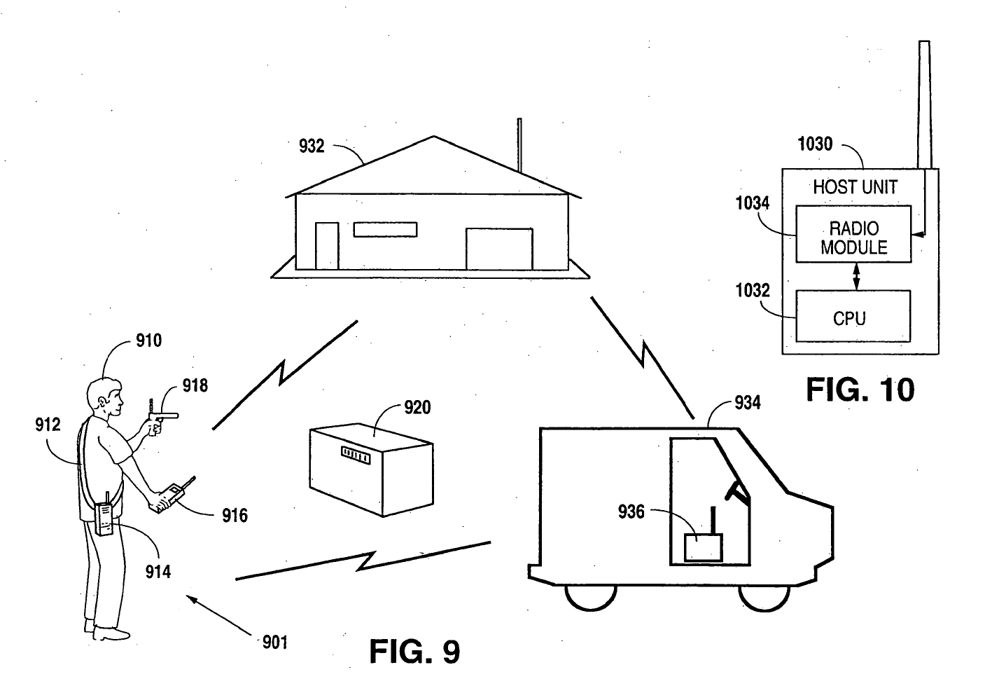

FIG. 9 illustrates operation of a personal LAN 901 according to the present invention in a route delivery scenario. In such operation, the user 910 delivers packages 920 to remote locations after collecting the packages 920 at a central warehouse 932. Through interaction with the infrastructure network, the user 910 collects the packages 920 and places them into a designated delivery van 934, reading in bar-codes for each of the packages 920. Should the user 910 collect an incorrect package, one or more devices of the personal LAN 901 would notify the user 910 of his error. Upon completion of collection, the user 910 would then begin distribution of the packages 920.

The user 910 establishes the personal LAN 901 by collecting desired devices and requesting formation of the personal LAN 901 via one of the devices such at the terminal 916. The terminal 916 through wireless interaction with the collected devices delivers a list of candidate devices to the user 910 for selection. Thereafter, through the terminal 916, or other initiating device, the personal LAN 901 is formed.

At each distribution site, the personal LAN 901 may then establish communication with the infrastructure network, if necessary, via a relatively higher power wireless access point 936 contained within the delivery van 934. Such information would then be transmitted back to the warehouse 932 for distribution and verification. The access point 936 in the van 934 may participate with the personal LAN 901 as an infrastructure device or may be part of the personal LAN 901 itself.

Referring to FIG. 10, in a specific embodiment of the present invention, each of the devices within personal LAN may be referred to as a host unit 1030 that contains a central processing unit 1032 (“CPU”), a radio module 1034 and various other circuitry required by the particular device, e.g. printing components, scanning components, memory, etc. The CPU 1032 operates in conjunction with the radio module 1034 to allow the host unit 1030 to establish and/or join the personal LAN 901 as well as to participate within the personal LAN 901. In reducing power consumption of the host unit 1030 to prolong battery life, the CPU 1032 may place the radio module 1034 as well as other components of the host unit 1030, including itself, to sleep for various periods of time.

An Infrastructure Network (such as those managing a majority of wireless communication flow a premises) may depend on an access point for distributing messages to and from a host network as well as within the Infrastructure Network (i.e. from one station in the network to another). No physical address is assumed in either case and a flexible host interface is provided to allow connection to a variety of stations. The personal LAN provides a simple modem and an intelligent host interface option, e.g., providing an RS-232 or a serial 3V CMOS physical host interface option, and provides multi-point capability with a throughput of 19200 bps in any environment. The personal LAN also allows a user to select a set of devices and automatically configures itself depending upon the selection.

Each device (or host) that may participate in personal LANs will contain a radio module. The radio and host protocol are implemented by a microprocessor in the radio module. The microprocessor will handle framing for both interfaces (simultaneously) and buffering for several messages. The implementation of the host interface (in smart mode) will provide simple support for the host computer's implementation of its radio driver.

Most devices such as portable computing devices are configured to support both NDIS device drivers and Windows 95™ virtual corn ports. This allows printers to have a “corn” port of their own, and data may be sent to the radio for communication to other radio devices via a stream of bytes. An NDIS interface would allow standard higher level protocols to utilize the radio if this was desirable. Other devices will need to implement proprietary device drivers communicating to the radio using the 3V CMOS serial interface which may be connected to an RS-232 interface adapter. In the implementation a simple “C” language API may be used as a device driver.

In particular, the physical interface to the host device is one of the following: a 3V CMOS serial interface and with an adapter, an RS-232 interface. The type of control information sent over the interface, framing characteristics and data rates are programmable. Table 1 describes the 3V CMOS serial interface signals.

TABLE 1
Serial 3 V CMOS Host Signals

| Signal | Direction | Usage |
|---|---|---|
| TX | From Host | Serial data from host. |
| RX | From | Serial data from radio. |
| | Radio | |
| RTS | From Host | Request to send. This will power up the radio host |
| | | interface and interrupt the radio to indicate that the |
| | | host has a message. |
| CTS | From | Clear to send. The radio is powered up and the radio |
| | Radio | is ready to accept data on TX and send data on RX |
| RI | From | Interrupt to host to indicate that the radio has a |
| | Radio | message for host. When the radio asserts CTS, |
| | | RI will be unasserted. |
| RESET | From Host | This signal hard resets the radio. It will have a pull |
| | | up resistor so that it may remain unconnected. |
| DSR | From | The radio asserts this line when it has finished its |
| | Radio | reset process. It may be connected to RTS when |
| | | RTS is not managed by the host. This allows the |
| | | host interface to remain active. |

For RS-232, a secondary PC board connected to the 3V CMOS interface will provide RS-232 signal levels for all the serial interface lines (except Reset). Upon reset, the data rate will be 19200. A smart interface command can change the rate to one of 19200-115200. The asynchronous framing will be 8 bit, no parity and 1 stop bit. The least significant bit of each byte of data is sent first, after the start bit.

Two types of host control interfaces are provided. A dumb interface is used by devices that are pre-programmed and cannot directly control the radio device. In this case, a very simple hardware controlled modem device is emulated. A Lock command is included in the radio protocol so that one station using a smart host interface can dedicate for its use another station (such as a printer with a dumb interface), and thus prevent interleaved data or other such problems. This is a higher layer problem, but is included in the radio protocol to support devices using the dumb interface.

A smart interface is used when the host device is able to actively manage the radio. Upon reset, the radio assumes a dumb interface. The dumb interface passes just data. Control and selection of dumb devices, if required, is handled by the other end of the radio data link. RTS must be asserted by the “dumb” host. In those cases where the connected host device does not use RTS/CTS signaling, this may be accomplished by connecting the DSR signal from the radio to RTS. While RTS is asserted, the radio cannot power down its end of the host interface and thus will use more power. In cases where the host device can assert RTS and await CTS, the radio will power manage the host interface. While RTS is asserted, data can be sent to the radio. When either RTS is unasserted or a gap in character arrival occurs, the radio will send the data to one of the following destinations, in order of highest to lowest priority:
1. The destination device which has currently selected the radio connected to this host device.
2. The last device that communicated with a unicast message to this device.
3. The broadcast address.

The smart interface can control operation of the radio such as establishing networks, removing networks, collecting statistics, multi-point transmission, and the management of destination devices with dumb interfaces, etc. The Host establishes this interface by first asserting RTS (this is necessary to allow the radio unit to power up the host interface). It then await CTS from the radio. Next it unasserts RTS and immediately sends the escape sequence DLE (hex 10) followed by ENQ (hex 05). The radio will use this sequence to enter the smart interface mode. The host may then begin a sequence to communicate with the radio.

Once the smart mode has been entered, all further communication is encapsulated in frames as follows.

TABLE 2
Smart Mode Communication Frames

| Field | Size | | Usage |
|---|---|---|---|
| Length | 16 | bits | The number of bytes in the |
| | | | message, including Ctl, |
| | | | Sequence and Check |
| Ctl | 8 | bits | The command to the radio |
| Sequence | 8 | bits | Sequence number of message |
| Info | 0 . . . Length * 8 | bits | The information used by the |
| | | | command |
| Check | 8 | bits | Checksum of Length through |
| | | | Info fields, inclusive |

When the radio has a message to send to the host, it will assert RI. Whenever any message exchange is to occur, the host will assert RTS and await assertion of CTS by the radio. When the radio asserts CTS, it will assert RI. At this time bi-directional exchanges are possible until the host asserts RTS. If this occurs in the middle of a message/frame (either from or to the radio), the message/frame is considered aborted and must be resent. The receiver of a message/frame (other than the acknowledge frame) must acknowledge the message/frame.

The Ctl field is composed of two parts. The low 4 bits are the command and the high 4 bits are used as follows.

TABLE 3
CTL Field

| Bit | Name | Usage |
|---|---|---|
| 7 | Retry | This command is a re-transmission of a |
| | | previous command. |
| 6 | reserved | |
| 5 | More Data | The sending device has more data to send to |
| | | receiver |
| 4 | reserved | |

Table 4 below defines the commands from the host device to the radio.

TABLE 4
Commands from the Host Device to the Radio

| | Value | |
|---|---|---|
| Command | (hex) | Usage |
| Data | 0 | Data to send on the radio |
| Initiate | 1 | Initiate network |
| Status | 2 | Status request to radio |
| Ack | 3 | Positive acknowledgment of frame from radio |
| Join Response | 4 | Allow/disallow device to join network |
| Start Network | 5 | Start network with all accepted devices |
| Join Network | 6 | Join one of specified networks |
| Device | 7 | Manage remote destination for use by this host |
| Management | | |
| Diagnostics | 8 | Perform various radio diagnostic and service |
| functions | | |
| Set Parms | D | Set host interface parms |
| Version Request | E | Request the radio version information |
| Network | F | Network Management request or response |
| Management | | |

Table 5 defines the commands and status messages from the radio to the host.

TABLE 5
Commands from the Radio to the Host Device

| | Value | |
|---|---|---|
| Command/Response | (hex) | Usage |
| Data | 0 | Data received from the radio |
| Initiate Response | 1 | Response to Initiate network command |
| Status Response | 2 | Status response to host |
| Ack | 3 | Positive acknowledgment of frame from |
| | | host |
| Join Request | 4 | Device request to join network |
| Start Network | 5 | Network has been started |
| Response | | |
| Join Network | 6 | One of requested networks has been joined |
| Response | | |
| Device Management | 7 | Result of attempt to manage remote |
| Response | | destination |
| Diagnostic Response | 8 | Result of diagnostic request |
| Data Transmit Status | D | The status of last data request from host |
| Version Response | E | The version information of the radio. |
| Network | F | Network Management request or response |
| Management | | |

Each frame transmitted across the interface has a sequence number. A re-transmission of a frame will have the Retry bit set in the Ctl field and the same sequence number as the previous attempt. Ack frames will use the sequence number of the received frame that is being acknowledged. The sequence number is incremented for each unique frame (other than Ack frames) sent across the interface.

The Chk Field is a modulo 8 sum of all bytes in each command or response message including the Length field through the Info field. The receiver of the message will also calculate the checksum and if the calculated field equals the received field, immediately send an Ack frame response.

Both the radio and host will use the following command to pass data messages across the interface. The maximum number of data bytes is indicated in the version and status responses from the radio. The format of the command is as follows.

TABLE 6
Host Command to Pass Data Messages Across the Interface

| | Length | |
|---|---|---|
| Field | (octets) | Usage |
| Address | 2 | The destination of the message. All ones indicates |
| | | broadcast |
| Awake | 2 | The time in 0.1 seconds that the host radio should |
| Window | | remain awake after sending the data packet. |
| Data | Length | The data to send. This must not exceed the |
| | bytes | maximum number indicated by the radio |

The Initiate Command is used by the host to Initiate a new Microlink network. Upon receipt of this command, the radio will send Initiate commands on the radio control channels and pass all attach requests (that do not have duplicate source addresses) to the host. The format of the command is as follows:

TABLE 7
The Initiate Command

| | Length | |
|---|---|---|
| Field | (octets) | Usage |
| Network Id | 2 | The network id to use for the network. NOTE that a Network Id |
| | | with all bits set to one is a broadcast Network Id that should not be |
| | | used in this command. |
| Dwell Time | 2 | Dwell time of network in network ticks(one tick is approximately |
| | | 30.5 microseconds |
| Device | 2 | Number of beacon intervals between attempts to recover missing |
| Resync Time | | devices from network. |
| AgeFactor | 2 | Time in 0.1 seconds to age out inactive Node table entries. |
| Beacon | 1 | Time between beacons in hops. For example, a value of 1 is equal |
| Interval | | to Dwell Time |
| Transmit | 1 | Number of devices likely to transmit in any dwell interval. The |
| Devices | | radio will use this to calculate the RFP Window. This window |
| | | affects the link maintenance power. |
| Type Flags | 1 | This field defines the type of network and controls its |
| | | initialization. The field is composed of the following bit fields: |

| | |
|---|---|
| Bit(s) | Usage |
| 7 | Rejoin. Rejoin previous network. |
| 6 | Wakeup Defer. If one, the network requires additional |
| | hidden node protection. |
| 5 | Network Type. If one, the network is Infrastructured, |
| | otherwise it is a PAN. |
| 4 | Temporary Network. Don't save parms in eeprom. |
| 2-3 | Data Rate. Values are as follows: |
| 0 | 250 kbps. |
| 1 | 1 Mkbps. |
| 0-1 | Power. If Network Type is PAN, then this field indicates the |
| | power to use during initialization. Its values are as follows: |
| 0 | Transmit Initiate at lowest level (−60 dbm). |
| 1 | Transmit Initiate at level 1(−40 dbm). |
| 2 | Transmit Initiate at level 2(−20 dbm) |
| 3 | Transmit Initiate at full power(0 dbm) |

| | | |
|---|---|---|
| SAR | 1 | Rate at which to perform search and rescues for stations that are |
| | | “lost”. This is in Beacon times. |
| Ninfo | 1 | Length of Info field |
| Info | Ninfo | Any arbitrary information that the host would like distributed to |
| | | potential network joiners. |

To establish a PAN, the Data Rate would be 1, the Network Type would be 0 and the Power would be set to 0. An infrastructured network could set the Data Rate to 0 (if greater range is useful. This would be approximately 6 db additional link margin) or to 1, and the Type to 1. For PAN, if Rejoin is set, then the radio will attempt to “discover” the previous instance of the network before it sends the Initiate frame. If the previous network is “discovered”, then after the Initiate response, a Start command must not be sent because the network has already been rejoined. For Infrastructured networks, a Start is not needed as the network will start upon valid receipt of this command.

In response to an initiate network command the Initiate Response is generated.

TABLE 8
The Initiate Response

| | Length | |
|---|---|---|
| Field | (octets) | Usage |
| Status | 2 | Status of Initiate. Values are as follows: |
| | | 0 Initiate Command in progress. |
| | | 1 Infrastructured network started |
| | | 2 Network rejoined |
| | | 3 Invalid Parameter |
| | | 4 Network already Initialized/Started |

The Status Request/Response pair is used to get status information from the radio. This includes counters and network information. The format of the Status Request is as follows:

TABLE 9
The Status Request

| | Length | |
|---|---|---|
| Field | (octets) | Usage |
| Type | 1 | Type of request. Values are as follows: |
| | | 0 Request Statistics |
| | | 1 Request and Clear Statistics |

The format of the response is as follows:

TABLE 10
The Status Response

| Field | Size (bits) | Usage |
|---|---|---|
| MaxLength | 16 | Maximum length of data field in data command |
| Nmessage | 16 | Maximum number of outstanding messages |
| | | allowed |
| TxFrames | 32 | Number of frames successfully sent |
| TxError | 32 | Number of frames that retried out |
| Sync Lost | 32 | Number of times synchronization has been lost |
| Device Lost | 32 | Number of times devices have been detected as |
| | | out of communication |
| RxFrames | 32 | Number of received frames with good FCS |
| RxTooLong | 32 | Number of received frames that where too long |
| RxFCSErr | 32 | Number of received frames that had FCS errors |
| RxDuplicate | 32 | Number of frames detected as duplicates |
| Status | 16 | General status of adapter. Bit definition is as |
| | | follows: |

| | |
|---|---|
| Bit | Usage |
| 0 | In a network |
| 1 | This station initiated the network |
| 2 | This station transferred the network |
| 4 | This station is current network |
| | coordinator |
| 5 | Station currently out of sync |
| 6 | Low data rate (250 kbps) |

| | | |
|---|---|---|
| Address | 16 | Station address. |
| Network Id | 16 | Network id |
| Beacon | 16 | Time between beacons in network ticks |
| Interval | | (approximately 30.5 microseconds) |
| Dwell Time | 16 | Dwell Time of network in network ticks |
| Hop | 16 | Hopping Sequence of network |
| Sequence | | |

The Ack frame is sent by both the radio and host to acknowledge correct reception of a frame across the interface. The sequence number in the frame is copied from the frame being acknowledged. If an Ack is not received within 100 milliseconds, the sender will re-transmit the unacknowledged frame.

After a Initiate Command has been issued, Attach Request messages received by the radio will be sent to the host. This request indicates a remote device that has detected the host's attempt to Initiate a network and has requested to join that network. The host can accept or reject the device with the Join Response Command. The format of this request is as follows:

TABLE 11
The Join Request

| | Length | |
|---|---|---|
| Field | (octets) | Usage |
| Address | 2 | The address of the requesting device. |
| Type | 2 | Remote device type. The radio module has a type |
| | | selector on the PC board which is indicated by this |
| | | field. |
| Ninfo | 1 | Length of Info field |
| Info | Ninfo | Information that the remote device can pass. Smart |
| | | devices can pass information to their adapter in the |
| | | Join Network Command. For devices using a “dumb” |
| | | interface, a four byte radio serial number will be sent |
| | | in this field. The maximum length of this field is 16 |
| | | bytes. |

The Join Response is used to indicate acceptability of a remote device in the network that the host is Initiating. It is formatted as follows:

TABLE 12
The Join Response

| | Length | |
|---|---|---|
| Field | (octets) | Usage |
| Address | 2 | Address of remote device |
| Status | 1 | Accept status. Values are as follows: |

| | |
|---|---|
| 0 | Remote device is accepted. |
| 1-15 | Reserved for use by radio |
| 16-255 | Join Request is rejected. This code is passed |
| | to the device that requested joining. |

The Start Network Command is used to start a PAN once the host has determined that all required devices have joined. The Start Network Response is generated by the radio when the network has been successfully initialized (that is all expected devices are now in sync). This may be as a response to the Start Network command or when the Type field had the high bit set in an Initiate command and the previous instance of the network was re-discovered. It has the following format:

TABLE 13
The Start Network Response

| | Length | |
|---|---|---|
| Field | (octets) | Usage |
| Status | 2 | This field has the following values: |
| | | 0 New network started. |
| | | 1 Network already Started. |
| | | 2 Network not initialized. |

The Join Network Command is used to allow the host to join a network. It could be used to join a PAN or an infrastructured network. It is formatted as follows:

TABLE 14
The Join Network Command

| | Length | |
|---|---|---|
| Field | (octets) | Usage |
| Type | 1 | If the high bit of Type is set, the host requests that an attempt be |
| | | made to rejoin the previous network. The low bits are encoded |
| | | with the data rate at which to search for a network. The values |
| | | are as follows: |
| | | 0 250 kbps |
| | | 1 1 Mbps |
| | | 2 Either 250 kbps or 1 Mbps |
| Backup | 1 | This device will generate network beacons after this number of |
| Priority | | beacons have been missed in a PAN. In an infrastructured |
| | | network, this device will search for a new coordinator (roam) |
| | | after this number of missed beacons. |
| Nnet | 2 | The number of network ids in the Netlist field. |
| Netlist | Nnet * 4 | Each entry in this vector is a valid network id, type (2 byte) pair |
| | | that is acceptable to the host. NOTE that all ones is a broadcast |
| | | Network Id and indicates that any network of the associated type |
| | | is acceptable to this host. |
| Scan Time | 1 | Time in 0.1 seconds that device will scan control channels for |
| | | network after connectivity is lost. See below. |
| Scan Duty | 1 | After Scan Time of scanning, the radio will be power cycled |
| Cycle | | during scan based on this value. Valid values are as follows: |
| | | 0 Radio remains powered on and scanning |
| | | 1 Radio is on for one pass through control channels and off a cycle |
| | | 2 Radio is on for one pass and off for two |
| | | 3 Radio is on for one pass and off for three |
| | | 4 Radio is on for one pass and off for four |
| Ninfo | 1 | Length of information field that is to be sent in Attach request |
| Info | Ninfo | Attach response info field. |

If the rejoin bit is set in the Type field, then the radio will attempt to rejoin the previous network. If it is not set or a rejoin attempt fails, the Netlist is used to find an appropriate network to join. If the Type field indicates either data rate is valid, the radio will alternate between the two rates while awaiting either Init or Beacon frames.

The radio uses the Scan Time and Scan Duty Cycle fields to determine how to recover when network connectivity is lost. Scan Time indicates how long to continuously scan when connectivity is first lost. Scan Duty Cycle indicates how to scan after Scan Time elapses. Essentially this allows the radio to power cycle its transceiver to aid in managing battery life.

The Join Network Response indicates to the host that one of the acceptable networks has been joined. It is formatted as follows:

TABLE 15
The Join Network Response

| | Length | |
|---|---|---|
| Field | (octets) | Usage |
| Status | 2 | Values for this field: |

| | |
|---|---|
| 0 | Network coordinator accepted request. |
| | Other fields in response |
| | are valid only in this case |
| 1 | Network coordinator node table is full |
| | (10 devices) |
| 16-255 | Network coordinator rejected with this |
| | reason |
| 256 | Invalid parameter in Join Network |
| | Command |

| | | |
|---|---|---|
| Network Id | 2 | The network id of joined network. |
| Type | 2 | The type of network joined (same encoding |
| | | as Initiate Command). |
| Ninfo | 1 | Length of Info field. |
| Info | Ninfo | Any arbitrary information from network |
| | | initiator. |

The Device Management Command provides various device management functions. It is valid to send only to “dumb” devices. It is formatted as follows:

TABLE 16
The Device Management Command

| | Length | |
|---|---|---|
| Field | (octets) | Usage |
| Address | 2 | Address of remote device to manage |
| Function | 2 | Function to request of remote device. It should be |
| | | one of the following: |
| | | 0 Request Control of device. |
| | | 1 Release Control of device. |
| | | 2 Force Release of device. |
| | | 3 Set Awake Window Duration. |
| Duration | 2 | This is a duration in 0.1 second increments. |
| | | For command 0, the time the requesting device will |
| | | hold the station. |
| | | For command 3, the time this station should remain |
| | | awake after every Data frame it sends on the radio. |

The Device Management Response is generated by the radio after an exchange with the remote device. It is formatted as follows:

TABLE 17
The Device Management Response

| | Length | |
|---|---|---|
| Field | (octets) | Usage |
| Address | 2 | Address of remote device. |
| Func- | 2 | Function requested of remote device. |
| tion | 2 | Result of request. It is one of the following: |
| Status | | 0 Successful command. If the command was to |
| | | request control, then the remote device will not accept |
| | | data messages from any other device except this host |
| | | until this host sends a release command. If the |
| | | command was release, then the remote device is now |
| | | released. |
| | | 1 Device already controlled by device whose address is |
| | | in the next field. |
| | | 2 Device unknown or not responding. |
| | | 3 Device is locally managed. |
| | | 4 Invalid Parameter. |
| | | 5 No Network |
| Control | 2 | If the status field is 1, then this is the address of device |
| Address | | that currently has control of remote device. |

The Diagnostics command is used to perform diagnostic and service functions on the radio. Its format is defined, but its content are implementation specific.

TABLE 18
The Diagnostics Command

| | Length | |
|---|---|---|
| Field | (octets) | Usage |
| Command | 2 | The diagnostic command or service request. |
| Data | 2 | Length of Data field. |
| Length | | |
| Data | Data Length | The information the radio uses to perform the |
| | | function |

The Diagnostics Response is generated by the radio as the result of a Diagnostics request. Only some requests may generate a response.

TABLE 19
The Diagnostics Response

| | Length | |
|---|---|---|
| Field | (octets) | Usage |
| Command | 2 | The diagnostic response code. |
| Data | 2 | Length of Data field. |
| Length | | |
| Data | Data Length | The information the radio uses to perform the |
| | | function |

The Set Parms Command is used to set the host interface parameters. It is formatted as follows:

TABLE 20
Set Parms Command

| | Length | |
|---|---|---|
| Field | (octets) | Usage |
| Interface | 2 | The bit rate to use for host interface. This must be |
| bps | | one of 19200, 38400, 57600 or 115200 |

Upon receipt of this command, the radio will change its host interface parameters and then assert RI.

The Data Transmit Status command from the radio is used to indicate result of last data command from the host. A Data Transmit Status will be generated by the radio for every Data request from the host. It is formatted as follows.

TABLE 21
Data Transmit Status

| | Length | |
|---|---|---|
| Field | (octets) | Usage |
| Status | 1 | The result of the Data request. It is one of: |
| | | 0 Successful transmission |
| | | 1 Could not send, no network |
| | | 2 Could not send, device unreachable (retries used up) |
| | | 3 Could not send, device unknown |
| | | 4 Could not send, no buffer |
| | | 5 Could not send, length error |
| Se- | 1 | Sequence number of Data request from host. This can |
| quence | | be used to match up responses with requests. |
| Address | 2 | Destination address of Data Request |

The Version Request command is used to request version information from the radio module. There is no data associated with this request.

The Version response is generated by the radio upon receipt of a version request. It is formatted as follows.

TABLE 22
Version Response

| | Length | |
|---|---|---|
| Field | (octets) | Usage |
| MaxLength | 2 | Maximum length of Data field in data command. |
| Nmessage | 2 | Maximum number of outstanding messages |
| | | allowed. |
| Version | 4 | Version of radio code. The high two bytes are the |
| | | version and the low 2 bytes are the revision. |
| Ninfo | 1 | Length of Info field. |
| Info | Ninfo | Text string indicated information about the radio |
| | | such as date of revision, etc. |

The Network Management command is used by the host to manage network operations and by the radio to indicate network management requests from the network.

TABLE 23
Network Management Command

| | Length | |
|---|---|---|
| Field | (octets) | Usage |
| Command | 2 | Responses have the high bit set. Each command |
| or Response | | requires a response across the interface. Valid values |
| | | are as follows: |
| | | 0 Remove host from network. The radio is removed |
| | | from the Microlink. If the radio was the network |
| | | coordinator, the network is terminated. |
| | | 1 Request device take over the network. This is used |
| | | to transfer network control from this station to another |
| | | device. If the destination devices accepts, it becomes |
| | | the network coordinator. If the other device is “dumb” |
| | | it will always accept this request. A smart device can |
| | | reject the request. |
| | | 2 Request network termination. This is a request from |
| | | this station to the network coordinator to terminate the |
| | | network. A “dumb” network coordinator will always |
| | | accept the request to terminate. |
| | | 3 Request device list from network coordinator. |
| | | 4 Request from network coordinator to this station to take |
| | | over coordination. |
| | | 5 Temporarily remove host from network. Host may rejoin |
| | | later. |
| | | 8000 Device removed from network. |
| | | 8001 Device will begin beaconing on next hop. |
| | | 8002 Device cannot take over network. |
| | | 8003 Request to Terminate accepted. |
| | | 8004 Request to Terminate rejected. |
| | | 8005 Device List. |
| | | 8006 This device is not network coordinator. |
| | | 8007 Request time-out. |
| | | FFFF No network |
| Reason or | 2 | For commands, this is a reason for the command. For a |
| Status | | response, it is the status. The status must be one of |
| | | those listed above. |
| Device | 4 * number | For Device List Response, a list of address:type pairs of |
| List | of devices | devices in network. |

To initiate a Smart Radio interface, the following steps are performed:
1. Assert RTS.
2. Wait for CTS
3. Immediately unassert RTS and send DLE ENQ
4. Wait for RI
5. Send Version Command
6. Wait for Version response to verify correct radio operation and protocol. Save the MaxLength field and Nmessage field from response for use in sending data commands.
7. Send Set Parm command to change bit rate to that desired
8. Wait for RI
9. Radio interface is initialized

To initiate a PAN network:
1. Generate Network Id. This could be a random number or a calculation on some known different value that the host has available (such as a serial number). Make sure it is not all ones.
2. Send Initiate Command to the radio. The Power field should normally be set low for PAN and high for infrastructure. In a PAN this will allow only devices very close to this host to receive the Initiate frames. The hop information should be different for any overlapping networks.
3. The radio will respond with an Initiate response indicating the command was accepted.
4. For each Join Request that is received by the host, determine the acceptability of the remote device. This could be done simply by looking at the type field, or it could be more complicated based on host knowledge of higher layer protocol. Send a Join Response message to the radio with the correct status.
5. Once all required devices have been detected, Send a Start Network Command to the radio.

To join a network:
1. Generate a list of acceptable Network Ids and types. For joining a PAN, it is likely that the Network Id is all ones (broadcast) and the type is PAN. This will allow the host to join any PAN that physically selects it by proximity. Set the data rate bits in the Type field of the Join Network request. Send the request to the radio.
2. Await the Join Network Response. Process Info field if meaningful. Data can now be sent.
3. Send Network Management command to get addresses and types of other stations in network.
4. Await the response and save information for use in generated data messages.

To send data:
1. Generate the Data command including awake window information (which may be zero). If the host requires that the radio remain awake to “immediately” receive a data frame, then the Awake Window field of the Data command should be set accordingly.
2. Send the message to the radio and increment outstanding Data count.
3. If outstanding Data count is less then Nmessage field in version or status response, another data command can be sent.
4. For each Data Transmit Status from radio, check status of outstanding message with same sequence number. Process status accordingly. Decrement outstanding Data count.

To transfer network control:
1. Generate a Network Management request to transfer control to a specific destination.
2. Await the Network Management response of acceptance from that device.
3. If device rejects, a request to another device can be tried.

To network initiator rejoining a network:
1. Generate an Initiate Command with same network id as that of network to rejoin. Set the high bit of the Type field and send to radio.
2. If the Initiate Response indicates the device has rejoined (and possibly resumed network coordination) then process is finished. If the Response is 0, then continue process as in step 4 of initiating a network.

Temporary Network:
1. If in a network already, issue Network Management command to temporarily be removed from that network. If not, go to step 3.
2. Wait for the response indicating removal.
3. Generate new network id for temporary network. Set Resync Time to a small number (so the network will quickly dissolve when network initiator exits. The network should be a PAN, power suitable to the application and the Initiate command must indicate that the network is temporary.
4. Initiate the network as in steps 3 through 5 of Initiating a PAN.
5. Exchange required Data.
6. Issue Network Management command to terminate network (i.e. remove network coordinator).
7. Wait for response that device is removed.
8. If in a previous network, and wishing to rejoin, that network can now be rejoined.

The frequency of the radio is in the 2.4 GHz range, selectable on 1.5 MHz increments from 2401 to 2483 MHz. This will allow for 50 channels. The radio data rates are software controlled and either 1 Mbps or 250 Kbps. The later can be used if greater range is desirable (as in an Infrastructured Network). The bit framing for the radio is Synchronous HDLC using NRZI encoding. An 80 bit preamble of alternating ones and zeros will be sent for each frame.

The radio supports relatively fast switching times between channels to allow FH Spread Spectrum solutions for noise immunity. Suggested worst case switch times are on the order of 500 microseconds. The transmit power should be no more than 0 dbm, and at 5 meters the BER should be no worse than 10⁻⁵.

The following elements of the radio protocol are common to personal LAN and to Infrastructured Networks.

General Frame Format

The framing is HDLC so starting and ending flags delimit the frame.

TABLE 24
General Frame Format

| Field | Size | Description |
|---|---|---|
| DA | 16 bits | Destination address |
| SA | 16 bits | Source Address |
| Network Id | 16 bits | Network Id from join response. All ones is |
| | | broadcast ID. |
| Sequence | 16 bits | Fragment number and sequence number |
| Reservation | 8 bits | Reservation indication. This is the duration in |
| | | (byte times + 7)/8 that the current frame sequence |
| | | requires to complete. It includes preamble times, |
| | | frame times and rx/tx switching times. |
| Ctl | 8 bits | Control field. Frame type |
| Info | 0 to | Information, if any |
| | 512 | |
| | bytes | |
| FCS | 16 bits | FCS protecting DA through Info inclusive |

Ctl Field

The low 4 bits is the frame type which is defined below. The high 4 bits have the following usage:

TABLE 25
Ctl Field

| Bit | Name | Usage |
|---|---|---|
| 7 | Retry | This frame is a retry. A previous attempt to transmit this |
| | | frame did not receive a CLR. The sequence field has the |
| | | same sequence number as the previous attempt. |
| 6 | Fragment | This frame is a fragment. The Sequence field contains the |
| | | fragment number |
| 5 | More Data | This station has more data to send to the receiver of this |
| | | frame |
| 4 | Last | This frame contains the last fragment. |
| | Fragment | |

Frame Types are defined below:

TABLE 26
Frame Types

| | Value | |
|---|---|---|
| Type | (hex) | Usage |
| Data | 0 | Data frame. |
| CLR | 1 | Acknowledge unicast frames of all types |
| | | except RFP. |
| RFP | 2 | Request For Poll. |
| Poll | 3 | Poll Device. |
| Beacon | 4 | Network Synchronization Message |
| Initiate | 5 | Initiate new PAN |
| Attach Request | 6 | Sending device indicates desire to join a |
| | | network |
| Attach | 7 | Response from network initiator to device that |
| Response | | has sent an Attach Request. |
| Identify | 8 | Message sent by network coordinator to |
| | | determine if destination device is still in sync. |
| Test | 9 | Test message. |
| Device | E | Command or response frame to manage remote |
| Management | | device. |
| Network | F | Special network management functions |
| Management | | |

Address Fields

The DA and SA fields are each 16 bits. Station Addresses are randomly generated by each station. Any randomization algorithm may be used, but it should be sure to generate different values on subsequent generation attempts. All ones is a broadcast address and should not be generated for use as the station address.

Network Id Field

The Network Id field is passed to the radio from the network initiator. All ones is a broadcast id and is not a valid id for a network but can be used to join any network sending a Initiate.

Sequence Field

This field is composed of two sub-fields. The high 4 bits are the fragment number (when the fragment bit is on in the Ctl field) and the low 12 bits are the sequence number of the frame. This number is changed on every frame sent, unless the frame is a retry (the retry bit is set in the Ctl field). For CLR frames, it is copied from the frame to be acknowledged. In all other frames, the number is incremented for each new frame sent.

Frame Check Sequence (FCS)

The FCS algorithm is CCITT CRC-16 as used by HDLC.

Certain channels, control channels, are set aside to be used specifically for synchronization and re-synchronization. The hop sequences will visit these channels more frequently. Several channels are used to prevent a single point of failure based on interference on a single channel.

The medium access rule used is CSMA/CA, that is carrier sense, multiple access with collision avoidance. All directed frames (except CLRs) require a CLR from the receiver to be transmitted to the sender of the directed frame.

CSMA alone would allow access to the medium as soon as it is sensed to be idle. If multiple devices simultaneously sensed idle and transmitted, there is a “collision” which cannot be detected. To detect these collisions a CLR is expected on all directed frames. This does not “avoid” collision in the first place. To avoid collisions, devices will first sense the medium for a random length of time, and only if the medium is idle for that random time will the device send. Beacon frames sent by the network coordinator will use a random time in the range of 0 to backoff_table[0]/2. All other frames use a range of 0 to backoff_table[0]. This allows beacons a higher priority. Occasionally a collision will still occur. The absence of a CLR will indicate this. It will also sometimes cause delay on sending the frame when there would have been no contention anyway. In any case it will prevent most collisions. Any collision results in a great delay of wasted bandwidth.

Since it is possible (especially in Infrastructured networks) to have hidden stations, a station may receive frames sent only by the recipient of a frame sequence (i.e. POLL and CLR frames) and it may not detect the carrier on the RFP and DATA frames. Frames therefore contain reservation information that indicate to all receiving stations the necessary time duration required for a frame sequence. This allows hidden stations to recognize that the medium is actually busy. Thus such stations will not inadvertently sense the carrier as idle and transmit a frame which interferes with a hidden station's frame. Stations are thus required to process reservation information in all frames having the correct Network Id.

A station that has just awakened from power down mode (i.e., the radio receiver has been off), does not have such an assessment of the medium. If such a device desires to send, and if the network is so configured (indicated by a field in Beacon frames), such devices will set their medium reservation information to protect against the longest possible frame. A valid frame received by such a station will set the reservation time to a known value, potentially shortening this duration.

Except when transmitting a CLR or POLL, the medium is first sensed for a carrier signal as defined above before transmitting a frame. If the medium is busy, then the backoff procedure is initiated.

A backoff value is randomly chosen in the range of 0 to backoff_table[retry]. The retry will initially be zero for a frame. The table, backoff_table, is composed of the following values: {65, 130, 260, 520}. Each entry is in system ticks, where each tick is approximately 30.5 microseconds. The backoff timer runs regardless of the state of the medium. However, when a frame is received, the timer is augmented by the reservation indicated in that frame (based on transmit data rate). The value in the frame is designed to protect that frame and any subsequent frame in the sequence. This results in fairer access to the medium because other stations that attempt to transmit later will not have better access probability due to a station continually timing out its backoff count and picking ever larger times to wait. Once the backoff timer goes to zero, the device will transmit its frame.

When frames are unsuccessfully sent, that is a POLL is not received for an RFP or a CLR is not received for a directed frame, the retry value is incremented and if the maximum number of retries has not been exceeded, the backoff procedure is again executed. The station must only transmit 4 successive times on a channel before awaiting another channel (that is why the table only has four entries). If retries must occur on a subsequent channel, the algorithm is reset. Note that if a CLR was sent but not successfully received, a duplicate frame will be sent, with the retry bit set in the control field and the sequence number the same. This will allow duplicate frames to be ignored by the receiver. Though they may be ignored, the CLR must still be sent.

Once the frame has been successfully sent, the backoff procedure is again initiated with a value randomly chosen in the range of 0 to backoff_table[retry]. The value of retry is then set to 0. This will prevent the station from having a higher access probability than other “backed off” stations.

Because the radio is an inherently poor medium, sending very long frames of data is inappropriate. Thus fragmentation may be required. Host data messages larger than the maximum radio frame size will be split into the appropriate number of fragments (from 1 to 15) and then each fragment will be sent with a separate medium access. A receiver will receive each fragment and assemble them into a single Host data message. The receiver may not have available buffers for fragments and can thus use the POLL frame status field to inform the RFP sender to re-transmit from the first fragment. The receiver of successive fragments will remain awake to receive all the fragments. Thus the transmitter of the fragments need not indicate them in the RFP window. Only unicast data frames can be fragmented.

The following describes the radio frame formats used. The Data frame is used to exchange host data between radios. Its format is as follows.

TABLE 27
Data Frame

| | Length | |
|---|---|---|
| Field | (octets) | Usage |
| Awake | 2 | The time in 0.1 seconds that the transmitter will |
| Window | | remain awake after completion of frame exchange |
| | | (unicast data exchanges require a CLR, broadcast |
| | | do not) |
| Data | 0-512 | Data to send |

The CLR frame is used to confirm error free reception of Data, Attach Request, Attach Response and Device Management frames. It has no data field.

The Request For Poll (RFP) frame is used to indicate one of the following:
1. The sender has a message for another station and is requesting permission to send that message.
2. The sender has a message for every station (broadcast DA).

This frame is usually sent in the RFP window (because the destination station is usually asleep in most cases). If the destination has indicated in a previous data frame that it will remain awake, and a subsequent frame is ready to be sent to that station, the RFP may be sent outside of the RFP window.

If sent in the RFP window, the duration field should only protect the POLL. If sent outside the RFP window, the duration should protect.

The POLL frame is sent in response to a unicast RFP. It indicates that the sender allows the receiver to send a subsequent message. Its format is as follows:

TABLE 28
POLL Frame

| | Length | |
|---|---|---|
| Field | (octets) | Usage |
| Status | 8 | Status in response to RFP. It is one of the following: |
| | | 0 RFP transmitter may send message. |
| | | 1 RFP transmitter can not send message. |
| | | 2 RFP fragment/sequence error. Sender should resend |
| | | from first fragment. |

The Beacon frame is used by network coordinator to keep stations in synchronization. Beacon frames are always broadcast on the network. The Beacon format is as follows.

TABLE 29
Beacon Frame

| | Length | |
|---|---|---|
| Field | (octets) | Usage |
| Network | 2 | This is the timestamp of the beacon and is used to |
| Time | | synchronize receivers clocks. It is in network |
| Stamp | | ticks(approximately 30.5 microseconds). |
| Next | 1 | The high four bits are used as follows: |
| Beacon | | Bit(s) Usage |
| Time and | | 7 Infrastructured Network |
| Type field | | 6 Use hidden station wakeup rules |
| | | 4-5 Beacon Type. Values are as follows: |
| | | 0 Normal beacon from network coordinator. |
| | | 1 Reset Beacon from network coordinator. Reset |
| | | synchronization. |
| | | 2 Backup beacon. |
| | | A backup beacon is generated by a station other than |
| | | the network coordinator because no beacons from |
| | | the coordinator have recently occurred. |
| | | The low four bits is the number of hops before the |
| | | next beacon. |
| Beacon | 1 | Beacon interval. Time is in units of hop dwells. |
| Interval | | |
| Beacon | 2 | Count of beacons, modulo 65536. This can aid in |
| Count | | synchronizing clocks that are fairly imprecise. |
| RFP | 2 | RFP Window time in network ticks. |
| Window | | |
| Device | 2 | Number of beacons that can be missed before |
| Resync | | entering Resync mode. From Start Network |
| Time | | Command. |
| Dwell | 2 | Time in each dwell in network ticks. |
| Time | | |
| Hop | 1 | Hop sequence being used by radio. (table in use) |
| Sequence | | |
| Hop | 1 | Current hop. (entry in table) |
| Channel | 1 | Actual channel that beacon is transmitted on. Used |
| | | because of possibility of hearing adjacent channel. |

It is most likely that dwell time and beacon interval are the same. There is little value in having beacon intervals longer than the dwell time unless a great deal of interference is suspected. This will allow for better frequency diversity recovery in bad channels.

The Initiate frame is used to establish a network. Devices receiving this will determine if the network parameters are acceptable and request to join by sending a Attach Request Frame. This frame is always broadcast. Its format is as follows.

TABLE 30
Initiate Frame

| | Length | |
|---|---|---|
| Field | (octets) | Usage |
| Type | 1 | The type of network. Valid types are as follows: |
| | | 0 PAN |
| | | 1 Infrastructure Network |
| Info | 0-16 | Information from the Initiate Network Host |
| | | Interface command |

The Attach Request frame is generated by a station when it receives an Initiate frame from a network that it wishes to join. It is broadcast in response to an Initiate frame (to the network id indicated by that frame). It may be sent as a directed frame to keep network connectivity. Its format is as follows.

TABLE 31
Attach Request Frame

| | Length | |
|---|---|---|
| Field | (octets) | Usage |
| Address | 2 | The address of sending device. |
| Type | 2 | The type field from the radio adapter selection device. |
| Info | 0-16 | Information from Host Join Request command, if any. |
| | | If device uses a dumb host interface, the radio serial |
| | | number (4 bytes) is sent in this field. |

The Attach Response frame is used to indicate acceptability of device to network initiator. Its format is as follows.

TABLE 32
Attach Response Frame

| | Length | |
|---|---|---|
| Field | (octets) | Usage |
| Status | 1 | The status of Attach Request. Valid values are as |
| | | follows: |
| | | 0 Accepted. |
| | | 1 Address Conflict, choose another address and try |
| | | again |
| | | 2 Host rejected. The next byte has the reason |
| | | 3 Network coordinator rejected because its node |
| | | table is full |
| Reason | 1 | If status is 2, then this is the host reason code for |
| | | rejecting join. |

The Identify frame is used to determine if the destination is still in sync. It has no data field and a CLR is all that is required for confirmation. This frame must be sent in the RFP window as it will take the same amount of time in that window to send the Identify Frame and receive a CLR as to send an RFP and receive a POLL. In the later case, the Identify frame would then need to be sent after the RFP window anyway using even more bandwidth. This frame must be unicast.

The Test Frame is used to test network connectivity. The receiver of such a frame will simply send it back to the sender. A special case exists, where a TEST is received with an all ones Network ID. This is the only case where such a frame is valid. The receiver will send back the frame. The Info field can contain any data.

The Device Management frame is used to acquire/release control of a remote device, usually one having a “dumb” host interface. This is usually best left to a higher layer protocol, but for dumb devices, that is not possible. The format of a request is as follows.

TABLE 33
Device Management Request Frame

| | Length | |
|---|---|---|
| Field | (octets) | Usage |
| Type | 1 | This must be zero to indicate a request to manage. |
| Command | 1 | Valid values are as follows: |
| | | 0 Request sole control of device |
| | | 1 Release control of device |
| | | 2 Force release of device |
| | | 3 Set Awake Duration |
| Duration | 2 | This is a duration in 0.1 second increments. |
| | | For command 0 it is the max. time the device will |
| | | remain locked. |
| | | For command 3 it is the duration this station will |
| | | remain awake after sending a Data frame. |

The format of a response is as follows:

TABLE 34
Device Management Response Frame

| | Length | |
|---|---|---|
| Field | (octets) | Usage |
| Type | 1 | This must be a one to indicate response to a |
| | | management request. |
| Command | 1 | Command for which this is response. See table |
| | | above for values. |
| Status | 1 | Valid values are as follows: |
| | | 0 request accepted |
| | | 1 request rejected because another device already |
| | | has control. That device's address is in the |
| | | next field. |
| | | 2 device is locally managed |
| Address | 2 | Address of device that already controls remote |
| | | device |

The Network Management frame is used to perform special network management operations such as transferring network coordination and network termination. There are request and response frames. The request frame is as follows.

TABLE 35
Network Management Request Frame

| | Length | |
|---|---|---|
| Field | (octets) | Usage |
| Type | 1 | This must be zero to indicate a request to manage. |
| Command | 1 | Valid values are as follows: |
| | | 0 Transfer network coordination request. |
| | | 1 Network termination request. Only a station acting |
| | | as network coordinator can accept this request. |
| | | 2 Device exiting network. |
| | | 3 Device list request. |
| Reason | 2 | Reason for request copied from Network |
| | | Management Host interface command. |
| Device | 2 | Used with Transfer network coordination request to |
| Addresses | | transfer list of know devices in network |
| | | (including self). |

The format of a response is as follows:

TABLE 36
Network Management Response Frame

| | Length | |
|---|---|---|
| Field | (octets) | Usage |
| Type | 1 | This must be a one to indicate response to a |
| | | management request. |
| Command | 1 | Command for which this is response. See table |
| | | above for values. |
| Status | 1 | Valid values are as follows: |
| | | 0 request accepted. |
| | | 1 request rejected. |
| Device | 2 * number | If the command is Device list request, this is a |
| List | of network | list of address:type pairs of all stations in |
| | devices | network and their type value as coded in the |
| | | attach request. |

Upon successful transfer of the network, the receiving device will begin beaconing and will send a reset beacon. That station also will need to set its identify procedure up to start from its initial state to confirm that all devices remain in synchronization based on the stations clock.

Network Synchronization

The network coordinator will keep the network synchronized by periodically transmitting Beacon frames. These frames include information about network time, dwell time and next beacon time to allow a receiver to set its clock to that in the beacon and then sleep until the next beacon with the receiver off to save power. Since a system clock with an accuracy of greater than 50 parts per million is unreasonable to assume, the beacon also includes a count of beacons that have been sent to allow the receiver to occasionally take snapshots of its own clock and then some large number of beacons intervals later, sample the beacon count again and determine the station clock's relative accuracy versus the network clock. Periodic corrections can then be applied.

The network clock is in 1/32768 seconds or approximately 30.5 microsecond ticks. This allows for a low power requirement to maintain the clock.

The Beacon frame contains hop information, the current physical channel, the hop table in use, the table entry and the dwell interval. The time remaining in the current dwell period is calculated as follows:

(dwell interval)−(current system tick)MOD(dwell interval)

Initial synchronization in Infrastructured networks is accomplished by setting the unsynchronized station's receiver to a control channel and awaiting a beacon with the Infrastructured bit set and a matching Network Id in the beacon frame.

### Detection of Loss of Synchronization

A PAN has two levels of synchronization support. When the number of beacons specified in a stations backup priority (from Join Network Command) are missed, the station will generate backup beacons. It will continue to adjust its clock to what the network coordinator would have as its clock. This allows for PANs to be temporarily split. If the station does not receive a beacon from the network coordinator after the number of beacon intervals specified in the Device Resync Time (from a beacon) have elapsed, then the station is lost, and must enter the recovery procedure.

An infrastructured network does not support splitting. The backup priority field is thus used for detection of sync loss. If backup priority beacon intervals pass without a beacon from the network coordinator, then the station is out of sync and must enter the recovery procedure.

Power Management

In order to reduce power consumption, a station must turn off its radio receiver (and perhaps other hardware). This is known as sleep mode. It may do so under the following conditions:
1. It has not indicated to any other station via a Data frame that it will remain awake.
2. It is not backing off after transmitting.
3. It does not have a frame to transmit to a known awake station.
4. It did not receive an RFP in the most recent RFP Window.
5. It is not “lost”. If it is lost it must remain awake on some control channel.

Following beacons all stations are obliged to be awake for a period of time called an RFP window. During this window, stations that have messages to send will generate Request For Poll (RFP) messages. Any station receiving an RFP must remain awake until it has correctly received the message from the station sending the RFP. The length of the RFP window is indicated in the beacon. The window size is based on the expected number of devices that may transmit (a parameter in the Start Network Command). Because it is likely that more than one device will need to send an RFP in the RFP window, each station will initiate the backoff procedure before sending an RFP. It is assumed that twice this expected number is a good value to use for the upper range in the randomization for the backoff algorithm. It is further assumed that twice this number is a good choice for the maximum allowed RFPs in the window. Once the window time has passed, no further RFPs are allowed to be transmitted.

If the frame sent cannot be successfully delivered in the current hop, another RFP must be sent in the next RFP window.

The window time is based on the Start Network command Transmit Devices field and is calculated as follows:

RFP Window Time=2*Transmit Devices* (Avg Backoff+RX/TX time+RFP message duration time+RX/TX time+POLL message duration time)

RFP message duration=14 bytes*8+80=192 microseconds (approximately)

POLL message duration time=15*8+80=200 microseconds

Avg RFP Backoff time=65*30.5 microseconds/2=990 microseconds

Since some clock jitter is to be expected, a station will actually turn on its receiver about 1 msec early on the expected channel and await the beacon. Since it must then receive a beacon and then wait the RFP window time, the current required to maintain the link can be calculated as follows:

Net Maintenance Current=Receiver Current*(Channel Select time+1 msec+Avg Backoff/2+RX/TX time+Beacon Frame Time+RFP window)/Beacon Interval+sleep current

Beacon Frame Time=31*8+80=328 microseconds (approximately)

As an example of this, assume Receiver Current of 100 mA, a channel select time of 0.5 msec, a beacon interval of one dwell period, a dwell period of 250 msec, a Transmit Devices value of 2 and a sleep current of 2 mA. The Net maintenance current is as follows:

$$\begin{matrix}RFP window = ( 2 * 2 * ( .99 ms + .5 ms + .192 ms + .5 ms + .2 ms ) ) \\ = 9.52 ms\end{matrix}$$

$$\begin{matrix}Current = 100 mA * ( .5 ms + 1 ms + .5 ms + .5 ms + .328 ms + RFP window ) \text{/} 250 msec + 2 mA \\ = 100 mA * 12.35 ms \text{/} 250 ms + 2 mA \\ = 6.94 mA\end{matrix}$$

When sending to a station that is assessed as in Awake Mode, an RFP-POLL-DATA-CLR sequence can be sent anytime except in the RFP Window. If during the first dwell time that this is attempted, the message can not be successfully transmitted, then the RFP Window method described above must be used to deliver the message.

Network Re-Synchronization

Since it is possible for a PAN to be divided when the user carries some equipment but not all, it is necessary to provide a mechanism to re-synchronize those devices which have lost synchronization because they no longer see beacons. The network coordinator will assess all devices in the network by using one of two mechanisms.

By monitoring RFP activity and its own traffic to other stations, it can determine which stations have recently been connected.

For those stations without recent demonstration of connectivity (case 1), the network coordinator will generate Identify frames.

For devices determined to be “lost”, a search and rescue mission will be attempted at the rate requested in the Host Interface Start Network command. After the requested number of beacons has passed, the network coordinator will wait for an indication of no activity involving it (again based on RFP frames and its own transmission status), and then tune to each of the control channels in succession and transmit beacon frames.

Lost devices will wait on one of the control channels and when they receive the beacon, they will re-sync to the information in the beacon and thus be recovered. With the periodic adjustment of a station's clock as defined above, a reasonable period will be provided over which synchronization can be maintained. Each beacon advertises the Device Resync Time. Thus a station that has not seen beacons for this period will start progressing very slowly through the control channels, waiting for beacons (as discussed above). Once it sees a beacon it will be back in sync. This progression requires the receiver to be on thus causing a large demand on power. The Join Network Command specifies an initial on time and a subsequent power duty cycle to allow for extended battery life. Once the initial on time passes (during which the station is scanning channels at slow rate), the radio will perform a single scan of the control channels followed by a period during which the receiver is off. This period is a multiple of the time required for a single scan and can be a 50%, 33%, 25% or 20% duty cycle. This will increase the re-acquisition time.

At this same time the station will become receptive to new Initiate frames that match the correct criteria as designated in the Host Interface Join Network Request. If it receives either a Initiate frame or a Beacon Frame, it will proceed accordingly. This will allow devices in a recharge rack overnight to automatically be ready for a new network the following morning. The search and rescue operations may also be employed to establish a PAN. A network may employ either or both search and rescue and proximal formation operations to establish a plurality of PANs.

Infrastructured Network Re-Synchronization

When an station in an infrastructured network looses synchronization (is lost), it will immediately search for a new network matching the parms from the Join Network Command. The station will start progressing very slowly through the control channels, attempting to detect a network matching the specified parameters. This progression requires the receiver to be on thus causing a large demand on power. The Join Network Command specifies an initial on time and a subsequent power duty cycle to allow for extended battery life. Once the initial on time passes (during which the station is scanning channels at a slow rate), the radio will perform a single scan of the control channels followed by a period during which the receiver is off. This period is a multiple of the time required for a single scan and can be a 50%, 33%, 25% or 20% duty cycle. This will increase the time required to find a network.

Reset Network Recovery

If a station is reset (i.e. the battery is replaced), it must re-acquire the network. The network itself cannot determine that the device is missing for the duration of the Device Resync Time. This can be quite long. This is resolved by the hop sequences incorporating the control channels in the sequence more frequently than other channels. Thus a device that is “lost” can tune its receiver to a control channel and await beacons. If the lost device is the network coordinator (the station normally transmitting beacons), then after a short number of missing beacons, another device will send backup beacons. Thus even the “lost” network coordinator will be able to recover the network and resume coordination.

The time to recover is on average as follows:

number of control channels*interval between using control channels/2

Thus if there are four control channels visited every fifth hop and the hop duration is 250 ms, then on average the recovery time is 2.5 s.

### Radio Finite State Machines (FSM)

This section defines the radio finite state machines and their operation. These FSMs are as follows:
1. Initial FSM
2. Initiate FSM
3. Network Management
4. Network Coordination FSM
5. Station FSM
6. Transmit FSM
7. Receive FSM

The inputs possible for the FSMs are the host interface commands and radio frames discussed in previous sections and various time-outs. The timers are as follows.

TABLE 37
FSM Timers

| Timer | Usage |
|---|---|
| NextBeacon | Time until next Beacon Frame |
| NextHop | Time until hop to next channel |
| RFPWindow | Time until RFP Window expires |
| Backoff | Current value of backoff counter. Stops running if |
| | Reservation Timers is running. |
| Reservation | Current reservation time for any outstanding receive |
| | sequence. |
| InSync | Maximum time station can maintain synchronization |
| | without Beacons. This will improve as more beacons |
| | are received. |
| NMTimer | Timer used to terminate states in network management |
| | FSM. |
| CLRTimer | Timer used to detect failed frame sequences such as |
| | RFP-POLL. (i.e. no POLL) |

TABLE 37
FSM Variables
Other variables kept on a station basis are as follows:

| | Non | |
|---|---|---|
| Variable | Volatile | Usage |
| network id | yes | the network id of Microlink that station is |
| | | attached to. |
| Station | yes | the address used by the station in the Microlink. |
| address | | |
| Station table | yes | addresses and types of every station in network. |
| Dwell time | no | hop dwell time. |
| Beacon | no | number of hop periods in a beacon interval. |
| interval | | |
| Hop table | yes | table of hop sequences. |
| Current | no | current channel radio is tuned to. |
| channel | | |
| Hop entry | no | current entry in hop table. |
| Hop | no | current hop sequence. |
| sequence | | |
| Initiator | yes | did station initiate network. |
| Transferred | yes | did station transfer network. |
| Coordinator | yes | is station network coordinator. |
| Station | no | queue of messages from host. Each entry has a |
| queue | | retry count which is zeroed upon first entry |
| | | into queue. Messages will be enqueued again |
| | | when a chan retry limit is exceeded. Message |
| | | requires use of RFP Window. |
| Retry | no | retry count of current transmit message. |
| Chan retry | no | retry count of current transmit message on |
| | | current channel. |
| Ready queue | no | queue of messages to hold until after RFP |
| | | Window. |
| Transmit | no | queue of messages that transmit state machine |
| queue | | will send. |
| Receive | no | queue of messages received by receive state |
| queue | | machine. |
| SAR flag | no | when flag is set: |
| | | if network coordinator, some stations are out of |
| | | sync. if not, this station is out of sync. |
| test alive | no | vector of counter to track Device Resync Time. |
| | | One per station in network |
| awake time | no | value set in Data Command from host. Radio |
| | | must stay in receive mode if non-zero |

In the following description, unspecified Inputs are assumed to be ignored. Only the first matched Input in a State is executed. A ‘*’ in the State field means this Input results in the same transition for all States. In the Next State column, a number implies a State in the current FSM and a number:name implies a State in the named FSM. A blank Next State field implies that there is no transition. When a transfer to a named FSM occurs, the current FSM is terminated. When frames are specified as Input, they are assumed to be removed from the receive queue.

The Initial FSM is entered upon module reset. The Join Request parms are set to the broadcast network id and a type of PAN and a Data Rate of any rate. The network management FSM, receive FSM and transmit FSM run asynchronously to other FSMs. A queue from receive and to transmit are assumed. There is also a station queue which holds frames from the host to transmit that may have arrived before an RFP window.

It is assumed that Host Data frames, Network Management frames or Device Management frames are preprocessed as follows:
1. If the station is not in the Station FSM or the Network Coordinator FSM, then an error is sent to the host, No Network.
2. If the destination is asleep, the frame is put on the station queue
3. If the destination is awake and network is not in an RFP Window, the frame is put on the transmit queue.
4. If the destination is awake and network is in an RFP Window, the frame is put on the ready queue.

TABLE 38
Initial FSM

| State | Input | Action | Next State |
|---|---|---|---|
| 0 | Initiate | Build Initiate Frame from command | 0: Initiate |
| | Network | and enqueue to transmit. Set | PAN |
| | (PAN) and not | NextBeacon to .33 seconds. Send | |
| | re-establish | Initiate Network Response | |
| 0 | Initiate | Build Beacon with required parms and | 0: Network |
| | Network | enqueue to transmit. Set Test Alive | Coordination |
| | (infrastructured) | count in all stations 1. NextHop = dwell time. | |
| | and not re- | | |
| | establish | | |
| 0 | Initiate | Tune to random control chan. | 1 |
| | Network and | InSync = time on control channel. | |
| | re-establish | | |
| 0 | Initiate Frame | Build Attach Request (from default or | 3 |
| | with matching | Join Network Request) and enqueue to | |
| | Network Id | transmit | |
| 0 | Join Network | Save parms for Attach Request | 0 |
| | Request and | | |
| | not re-establish | | |
| 0 | Join Network | Save parms for Attach Request. | 2 |
| | Request and | Tune to random control chan. | |
| | re-establish | Set InSync timer for time on control | |
| | | chan. | |
| 1 | Beacon for old | Save parms for next hop and beacon | 0: Network |
| | network id | time | Coordinator |
| | | Test Alive = 1 for all stations. Send | |
| | | Initiate Network Response | |
| 1 | InSync = 0 and | Tune to next control chan. | 1 |
| | total time to re- | InSync = time on control chan. | |
| | establish not 0 | | |
| 1 | InSync = 0 | Build Initiate Frame from command | 0: Initiate |
| | | and enqueue to transmit. | PAN |
| 2 | Beacon for old | Save synchronization and hop | 0: Station |
| | network id | information. | |
| | | NextBeacon = Beacon time. | |
| | | NextHop = dwell time. | |
| | | InSync = 5 s. | |
| | | Send Join Network Response to host. | |
| 2 | InSync = 0 and | Tune to next control chan. | 2 |
| | total time to re- | InSync = time on control chan. | |
| | establish not 0 | | |
| 2 | InSync = 0 | | 0 |
| 3 | Attach | | 4 |
| | Response | | |
| | Frame, status | | |
| | accepted | | |
| 4 | Beacon | Save synchronization and hop | 0: Station |
| | | information. | |
| | | NextBeacon = Beacon time. | |
| | | NextHop = dwell time. | |
| | | InSync = 5 s. | |
| | | Send Join Network Response to host. | |

TABLE 39
Initiate PAN FSM

| State | Input | Action | Next State |
|---|---|---|---|
| 0 | NextBeacon = 0 | Build Initiate Frame from command and | 0 |
| | | enqueue to transmit. Set NextBeacon to | |
| | | .33 seconds | |
| 0 | Attach | Send Join Request to Host | 0 |
| | Request, not a | | |
| | duplicate | | |
| | address | | |
| 0 | Attach | Build Join Response with status of | 0 |
| | Request, | failure, duplicate address. Transmit Frame | |
| | duplicate | | |
| | address | | |
| 0 | Join Response | Build Attach Response with status | 0 |
| | | indicated by Host. If status is acceptable, | |
| | | save device in network table. | |
| 0 | Start Request | Build Beacon with required parms and | 0: Network |
| | | enqueue to transmit. Set Test Alive | Coordination |
| | | count in all stations 1. NextHop = dwell time. | |
| 0 | Initiate | Build Initiate frame and enqueue to | 0 |
| | Request | transmit | |

### Network Management FSM

In this FSM, the following abbreviations are used.
NC means network coordinator
NMF means a network management frame.
NMC means a network management request/response from host.

TABLE 40
Network Management FSM

| | | | Next |
|---|---|---|---|
| State | Input | Action | State |
| * | Nmtimer = 0 | Send NMC response to host, type request | 0 |
| | | time-out. | |
| * | NMC Remove | Enqueue NMF of type device exiting | 0 |
| | Device from | network(broadcast) to transmit queue. Set | |
| | network and | NMtimer. Send Device removed from | |
| | not NC | network to host. Terminate station FSM | |
| | | and reset to initial FSM. | |
| * | (NMC Remove | Enqueue NMF of type terminate network | 0 |
| | Host or NMC | to transmit queue. Set NMtimer. Send | |
| | Terminate | NMC response to host. | |
| | Network) and | Terminate network coordination FSM | |
| | NC | and reset to initial FSM | |
| * | NMC Request | Send NMC Response 8006 to host | |
| | Device take | | |
| | over network | | |
| | and not NC | | |
| * | NMC Request | Build list and Send NMC Response 8005 | |
| | Device list and | to host | |
| | NC | | |
| * | NMC | Enqueue NMF of type request | 2 |
| | Terminate | termination to transmit queue. Set | |
| | Network and | NMtimer | |
| | not NC. | | |
| * | NMF request | Send NMC request to host | |
| | to terminate | | |
| | and NC | | |
| * | NMF request | Enqueue NMF response 8005 and device | |
| | device list and | list including this device to transmit | |
| | NC | queue. | |
| * | NMF request | Enqueue NMF response 8006 to transmit | |
| | device list and | queue. | |
| | not NC | | |
| 0 | NMC Request | Enqueue NMF of type Request Take over | 1 |
| | Device take | network to transmit queue. Set NMtimer. | |
| | over network | | |
| | and NC | | |
| 0 | NMC Request | Enqueue NMF of type Request Device | 3 |
| | Device list and | list to transmit queue. | |
| | not NC | | |
| 0 | NMF request | Send NMC request to host | 0 |
| | transfer NC | | |
| | and NC | | |
| 0 | NMF request | Enqueue NMF response 8002 to transmit | 0 |
| | transfer NC | queue | |
| | and not NC | | |
| 0 | NMF response | | |
| | 8001 and not | | |
| | NC | | |
| 1 | NMF response | Terminate Network Coordinator FSM | 0 |
| | 8001 and NC | and start station FSM. Send NMC | |
| | | response to host. | |
| 1 | NMFresponse | Send NMC response to host | 0 |
| | 8002 and NC | | |
| 2 | NMF response | Send NMC response to host. | 0 |
| | 8003 and not | | |
| | NC | | |
| 2 | NMF response | Send NMC response to host | 0 |
| | 8004 and not | | |
| | NC | | |
| 3 | NMF response | copy device list and send NMC response | 0 |
| | 8005 and not | to host | |
| | NC | | |
| 4 | NMC response | Enqueue NMF frame to transmit queue. | 0 |
| | to transfer | Terminate station FSM. Init Network | |
| | request status | Coordinator FSM to state 0. | |
| | 8001 | | |
| 4 | NMC response | Enqueue NMF frame to transmit queue. | 0 |
| | to transfer | | |
| | request status | | |
| | 8002 | | |

### Network Coordination FSM

The Identify Procedure will check for all stations that this station has not detected traffic from within the Test Alive Count (number of beacons). It will build a list of stations to send Identify messages to and put them on the station queue. If several attempts to Identify a station fail, the SAR (search and rescue) flag is set. Receiving CLR or RFPs from a station will count as detected traffic. Note that after Start Request is received, the Test Alive variable is set to the 1. This will cause the network coordinator to immediately test for stations in the net on the first hop. This will guarantee that all stations in the network are together. Once it is first determined that all devices have synchronized, a Start Network Response is sent to the host.

TABLE 41
Network Coordination FSM

| State | Input | Action | Next State |
|---|---|---|---|
| 0 | NextBeacon = 0 | Hop to next channel. Reset NextHop and | 1 |
| | | NextBeacon to correct values. Build | |
| | | Beacon and transmit. Execute | |
| | | IdentifyProcedure. | |
| | | If station queue not empty, transfer to | |
| | | transmit queue, indicating RFP in RFP | |
| | | Window required. Set RFPWindow | |
| | | timer. | |
| 0 | NextHop = 0 | Hop to next channel. Reset NextHop | |
| 1 | RFP Frame | Save source address and mark related | 0 |
| | | station entry as having a message for this | |
| | | station. | |
| 1 | RFPWindow = | copy ready queue to transmit queue. | 2 |
| | 0 and (ready | | |
| | queue not | | |
| | empty or RFPs | | |
| | received) | | |
| 1 | RFPWindow = | | 0 |
| | 0 and awake | | |
| | window not 0 | | |
| 1 | RFPWindow = | Tune to first control channel and send | 3 |
| | 0 and SAR | Beacon | |
| 1 | RFPWindow = 0 | Enter Sleep mode | 0 |
| 2 | Attach | Send Join Request to Host | 2 |
| | Request, not a | | |
| | duplicate | | |
| | address. | | |
| | This station is | | |
| | coordinator. | | |
| | Network is | | |
| | infrastructured | | |
| 2 | Attach | Build Join Response with status of | 2 |
| | Request, | failure, duplicate address. Transmit | |
| | duplicate | Frame | |
| | address | | |
| 2 | Join Response | Build Attach Response with status | 2 |
| | | indicated by Host. If status is acceptable, | |
| | | save device in network table. Transmit Frame | |
| 2 | Data Frame | Send Data Command to Host | 2 |
| | and more | | |
| | expected | | |
| | frames | | |
| 2 | Data Frame, no | Send Data Command to Host | 2 |
| | more expected | | |
| | frames, and not | | |
| | all transmitted | | |
| 2 | All received, | | 0 |
| | All transmitted | | |
| | and awake | | |
| | window not 0 | | |
| 2 | All received, | Tune to first control channel and send | 3 |
| | All transmitted | SAR beacon | |
| | and SAR | | |
| 2 | All received, | Enter Sleep mode | 0 |
| | All transmitted | | |
| 3 | Beacon | Tune to next control channel and send | 3 |
| | Transmit Done | Beacon | |
| | and more | | |
| | control | | |
| | channels | | |
| 3 | Beacon | Enter Sleep mode | 0 |
| | Transmit done | | |
| | and no more | | |
| | control | | |
| | channels | | |

### Station FSM

The AdjustClock procedure will sample beacons over a long time period (on the order of 10 s of seconds) and determine the delta between the network coordinators clock (which is the network clock) and this stations clock. It will adjust the station clock in the absence of beacons.

The ModifyClock procedure will determine if the network clock in this station should be modified based on the calculations of AdjustClock. It also will set SAR if it is determined that sync can no longer be maintained by checking the InSync timer.

TABLE 42
Station FSM

| | | | Next |
|---|---|---|---|
| State | Input | Action | State |
| 0 | NextBeacon = | Hop to next channel, Set NextBeacon and | 1 |
| | 0 | NextHop to correct values. If station | |
| | | queue not empty, transfer to transmit | |
| | | queue, indicating RFP in RFP Window | |
| | | required. Execute ModifyClock | |
| 0 | NextHop = 0 | Hop to next channel. Set NextHop to | 1 |
| | | correct value. | |
| 1 | Beacon Frame | Set Network Clock and other parameters. | 0 |
| | (not backup | Execute AdjustClock. | |
| | beacon) | | |
| 1 | RFP Frame | Save source address and mark related | 0 |
| | | station entry as having a message for this | |
| | | station. | |
| 1 | RFPWindow = | copy ready queue to transmit queue. | 2 |
| | 0 and (ready | | |
| | queue not | | |
| | empty or RFPs | | |
| | received) | | |
| 1 | RFPWindow = | | 0 |
| | 0 and awake | | |
| | window not 0 | | |
| 1 | RFPWindow = | Tune to first control channel and send | 3 |
| | 0 and SAR | Beacon | |
| 1 | RFPWindow = | Enter Sleep mode | 0 |
| | 0 | | |
| 2 | Data Frame | Send Data Command to Host | 2 |
| | and more | | |
| | expected | | |
| | frames | | |
| 2 | Data Frame, no | Send Data Command to Host | 2 |
| | more expected | | |
| | frames, and not | | |
| | all transmitted | | |
| 2 | All received, | | 0 |
| | All transmitted | | |
| | and awake | | |
| | window not 0 | | |
| 2 | All received, | Tune to first control channel. | 3 |
| | All transmitted | | |
| | and SAR | | |
| 2 | All received, | Enter Sleep mode | 0 |
| | All transmitted | | |
| 3 | Beacon | Set Network Clock and other parameters. | 1 |
| | | Execute AdjustClock. | |

### Transmit Frame FSM

This FSM does not illustrate fragmentation. The inputs are either a frame at the head of the transmit queue, the backoff timer or the CLRTimer. For simplification, frames remain at the head of the queue until acted upon by an Action.

TABLE 43
Station FSM

| | | | Next |
|---|---|---|---|
| State | Input | Action | State |
| 0 | Frame in | if Beacon then backoff = | 1 |
| | transmit queue | backoff_table[0]/2 | |
| | | else backoff = backoff_table[0] | |
| 1 | backoff = 0 | Transmit frame. remove from queue. | 0 |
| | medium is idle. | | |
| | head of queue | | |
| | is Beacon. | | |
| 1 | backoff = 0 | Transmit frame. remove from queue. | 5 |
| | medium is idle. | Backoff = backoff_table[chan retry] | |
| | head of queue | | |
| | is broadcast. | | |
| 1 | backoff = 0. | transmit RFP on radio. Set CLRTimer. | 2 |
| | medium is idle. | | |
| | In RFP | | |
| | window. | | |
| 1 | backoff = 0. | Transmit RFP on radio. Set CLRTimer. | 3 |
| | medium is idle. | | |
| | RFP required. | | |
| 1 | backoff = 0. | Transmit frame on radio. Set CLRTimer | 4 |
| | medium is idle. | | |
| 1 | backoff = 0. | Delete head of transmit queue. send Data | 0 |
| | retries used up. | Transmit status to Host. | |
| 1 | backoff = 0. | Retry = retry + 1. | 5 |
| | chan retries not | Chan retry = chan retry + 1 | |
| | used up. | backoff = backoff_table[chan retry] | |
| 1 | backoff = 0. | put frame back on station queue and save | 0 |
| | chan retries | retry count | |
| | used up. | | |
| 2 | POLL | put frame on ready queue | 0 |
| | received. | | |
| 2 | CLRTimer = 0. | Delete head of queue and send Data | 5 |
| | retries used up | Transmit status to Host. | |
| | | Backoff = backoff_table[chan retry] | |
| 2 | CLRTimer = 0. | Retry = retry + 1. put frame back on | 0 |
| | | station queue and save retry count | |
| 3 | POLL | Transmit frame at head of transmit | 4 |
| | received. | queue. set CLRTimer. | |
| 3 | CLRTimer = 0. | Delete head of queue and send Data | 5 |
| | retries used up. | Transmit status to Host. | |
| | | Backoff = backoff_table[chan retry] | |
| 3 | CLRTimer = 0. | retry = retry + 1 | 0 |
| | chan retries | put frame back on station queue and save | |
| | used up | retry count | |
| 3 | CLRTimer = 0. | Retry = retry + 1 | 1 |
| | | chan retry = chan retry + 1 | |
| | | backoff = backoff_table[chan retry] | |
| 4 | CLR received. | Delete head of queue. send Data | 5 |
| | | Transmit status to Host. | |
| | | Backoff = backoff_table[chan retry] | |
| 4 | CLRTimer = 0. | Delete frame and send Data Transmit | 0 |
| | retries used up. | status to Host. | |
| | | Backoff = backoff_table[chan retry] | |
| 4 | CLRTimer = 0. | Retry = retry + 1 | 1 |
| | | chan retry = chan retry + 1 | |
| | | backoff = backoff_table[chan retry] | |
| 5 | backoff = 0. | | 0 |

### Receive Frame FSM

Every received frame will set the Reservation Timer by the reservation within it. The reservation is assumed to be from the beginning of the frame. It is possible that this value may be used and then the frame has an invalid FCS. In that case it is optional to honor the reservation value. Only frames with good FCS checks and a Network Id matching the station's network id are processed.

This FSM does not illustrate the usage of fragmentation.

TABLE 44
Receive Frame FSM

| State | Input | Action | Next State |
|---|---|---|---|
| 0 | CLR to this | Pass to transmit FSM. | 0 |
| | station | | |
| 0 | POLL to | Pass to transmit FSM | 0 |
| | this station | | |
| 0 | RFP to this | Enqueue frame. Transmit POLL on | 0 |
| | station | radio. | |
| 0 | Broadcast | Enqueue frame. | 0 |
| | RFP | | |
| 0 | Unicast | Enqueue frame. Transmit CLR on | 0 |
| | Frame to | radio. | |
| | this station | | |
| 0 | Broadcast | Enqueue frame. | 0 |
| | Frame | | |
| 0 | Frame to | if this station is network | 0 |
| | other | coordinator, indicate that frame's | |
| | station | source station has had activity | |

The enclosed Appendix A entitled “Hardware Specification” provides details regarding the functionality and construction of a radio module built in accordance with the present invention. Appendix A is hereby incorporated herein in its entirety and made part of this specification.

Moreover, the scope of the present invention is intended to cover all variations and substitutions which are and which may become apparent from the illustrative embodiments of the present invention that is provided above, and the scope of the invention should be extended to the claimed invention and its equivalents. Finally, it is to be understood that many variations and modifications may be effected without departing from the scope of the present disclosure.

1-26. (canceled)

27. A wireless communication system comprising: a plurality of wireless devices, each wireless device including a radio capable of transmitting at both a higher power level and a lower power level; wherein the plurality of wireless devices initialize a wireless network when operating at the lower power level with said plurality of wireless device in close proximity; and after initialization of the wireless network, said plurality of wireless devices communicate with each other within said wireless network at the higher power level.

28. The wireless communication system of claim 27 wherein the radios of the plurality of wireless devices have a plurality of selectable power levels, and wherein one of said power levels is selectable prior to initialization of the wireless network.

29. The wireless communication system of claim 27 wherein the plurality of wireless devices are placed in close proximity of one another to initiate operation of the wireless network, and wherein operation of the wireless network is initiated at the lower power level through reduced power transmissions reaching wireless devices no more than a few feet away, said plurality of wireless devices after initialization, continuing to communicate at the higher power level where close proximity is not required.

30. A wireless communication system comprising: first and second wireless devices, said first and second wireless devices selectively operating at a very low power level and at a higher power level, said first wireless device when operating at said very low power level providing a reduced power transmission with a range limited to a very close proximity from said first wireless device; said first wireless device sending network information at said very low power level so as to be received by said second wireless device only when the second wireless device is within said very close proximity from said first wireless device; said second wireless device upon receipt of said network information, forming a wireless network with said first wireless device; and said first and second wireless devices after formation of the wireless network communicating with each other at said higher power level.

31. The wireless communication system of claim 30 with said first and second wireless devices operating at said very low power level during formation of said wireless network so as to provide reduced power transmissions reaching no more than a few feet away.

32. In a wireless communication system, a method of establishing a wireless network, said method comprising
selecting at least two wireless devices from a plurality of wireless devices, each capable of participation within the wireless network in a higher power mode;
placing the at least two wireless devices in close proximity to one another;
establishing the wireless network by interaction of the at least two wireless devices in a lower power mode; and
carrying out wireless network communications between said at least two wireless devices in the higher power mode.

33. In a wireless communication system, the method of claim 32 with said at least two wireless devices operating in said low power mode during establishing of said wireless network so as to provide reduced power transmissions reaching no more than a few feet away.

34. A wireless communication system comprising: a plurality of wireless devices, said wireless devices together participating in a wireless network when within range of one another; wherein, at user's selection, operation of the wireless network is automatically initiated through very low power radio frequency transmissions of less than minus forty dBm.

35. A wireless communication system according to claim 34, wherein operation of the wireless network is automatically initiated through very low power radio frequency transmissions of not greater than minus sixty dBm.

36. A wireless communication system according to claim 34, wherein operation of the wireless network is automatically initiated through very low power radio frequency transmissions of approximately minus sixty dBm.

37. A wireless communication system comprising: a plurality of wireless devices, said wireless devices together participating in a wireless network when within range of one another; wherein operation of the wireless network is automatically initiated for wireless devices selected by the user to be in very close proximity, the initiation of the network for the wireless devices selected by the user taking place through very low power radio frequency transmissions of less than minus forty dBm to avoid unintentional participation in network formation by unselected devices.

38. A wireless communication system according to claim 37, with the initiation of the network for the wireless devices selected by the user taking place through very low power radio frequency transmissions of not greater than minus sixty dBm.

39. A wireless communication system according to claim 37, with the initiation of the network for the wireless devices selected by the user taking place through very low power radio frequency transmissions of approximately minus sixty dBm.
